(19) United States
(12) Patent Application Publication
(10) Pub. No.: US 2013/0199995 A1
(43) Pub. Date: Aug. 8, 2013

(54) POROUS POLYMER MEMBRANES, METHODS OF MAKING, AND METHODS OF USE

(71) Applicants: Peng Jiang, Gainesville, FL (US); Hongta Yang, Taichung (TW)

(72) Inventors: Peng Jiang, Gainesville, FL (US); Hongta Yang, Taichung (TW)

(73) Assignee: University of Florida Research Foundation Inc., Gainesville, FL (US)

(21) Appl. No.: 13/878,455

(22) PCT Filed: Oct. 24, 2011
(86) PCT No.: PCT/US11/57484

§ 371 Date: Apr. 9, 2013

Related U.S. Application Data
(60) Provisional application No. 61/407,061, filed on Oct. 27, 2010.

(51) Int. Cl. B01D 67/00; F17D 3/01; G09F 19/20; B01D 69/02

(52) U.S. Cl. CPC B01D 67/0023; B01D 69/02; F17D 3/01; G09F 19/20
USPC 210/500.27; 428/131; 137/551; 40/406; 427/243; 427/510; 216/56

(57) ABSTRACT

Embodiments of the present disclosure may relate to porous polymer membranes, structures including porous polymer membranes, devices including porous polymer membranes, methods of using porous polymer membranes, methods of making porous polymer membranes, and the like.

### CROSS-REFERENCE TO RELATED APPLICATION

This application claims priority to U.S. provisional application entitled “POROUS POLYMER MEMBRANES, METHODS OF MAKING, AND METHODS OF USE,” having Ser. No. 61/407,061, filed on Oct. 27, 2010, which is entirely incorporated herein by reference.

### FEDERAL SPONSORSHIP

This invention was made with Government support under Contract/Grant No. CBET-0744879 and CMMI-1000686 from the National Science Foundation. The Government has certain rights in this invention.

### BACKGROUND

Mesoporous membranes, such as 2-D porous silicon and 1-D titania photonic crystals, have been widely used in sensitive vapor detection. By monitoring the change of the optical properties (e.g., wavelength shift of the photonic band gaps or the Fabry-Perot fringes) of the diffractive media during vapor condensation, the concentration of the vapors can be deduced. Blue-colored Morpho butterfly wing scales, which are intrinsic 3-D photonic crystals exhibiting unique optical diffraction and interference, have also been demonstrated for highly selective vapor detection. However, the limited size and material selection of these natural photonic crystals impede the development of reproducible and reusable vapor detectors.

### SUMMARY

Embodiments of the present disclosure provide for structures, methods of making a structure, devices, filters, display signs, and the like.

An embodiment of the structure, among others, includes: a porous polymer membrane including an ordered array of voids, wherein the distance between at least two pairs of adjacent voids is substantially the same, wherein a polymer framework separates the voids, wherein the voids extend the entire thickness of the porous polymer membrane to form a channel through the porous polymer membrane.

An embodiment of the device, among others, includes: a first structure, wherein the first structure is the structure as described herein, and a fluid structure adapted for moving a fluid into and out of a portion of the voids of the first structure, wherein the portion of the first structure has a first color when the fluid is within the void and a second color when the void does not

include the fluid, wherein the first structure and the fluid structure are in fluidic communication.

An embodiment of the filter, among others, includes a structure as described herein.

An embodiment of the display sign, among others, includes a structure as described herein.

An embodiment of the method of making a structure, among others, includes: disposing a monomer/nanoparticle mixture onto a surface to form an array of nanoparticles, wherein the distance between at least two pairs of adjacent nanoparticles is substantially the same; polymerizing the monomer to form a polymer framework around at portion of the nanoparticles; and removing the nanoparticles to form an ordered array of voids, wherein the distance between at least two pairs of adjacent voids is substantially the same, wherein the polymer framework separates the voids, wherein the voids extend the entire thickness of the porous polymer membrane.

Other structures, methods, features, and advantages of the present disclosure will be, or become, apparent to one with skill in the art upon examination of the following drawings and detailed description. It is intended that all such additional structures, methods, features, and advantages be included within this description, be within the scope of the present disclosure, and be protected by the accompanying claims.

### BRIEF DESCRIPTION OF THE DRAWINGS

Many aspects of the disclosed devices and methods can be better understood with reference to the following drawings. The components in the drawings are not necessarily to scale, emphasis instead being placed upon clearly illustrating the relevant principles. Moreover, in the drawings, like reference numerals designate corresponding parts throughout the several views.

FIG. 1.1 illustrates a polymer membrane including the nanoparticles and the polymer framework.

FIG. 1.2 illustrates a porous polymer membrane having voids where the nanoparticles were previously disposed.

FIG. 2.1(a) illustrates a top-view SEM image of a doctor blade (DB)-coated silica colloidal crystal-polymer nanocomposite having 320 nm silica spheres. FIG. 2.1(b) is a magnified image of FIG. 2.1(a). FIG. 2.1 (c) is a top-view SEM image of a templated macroporous polymer film. The inset shows a magnified portion of the film. FIG. 2.1(d) illustrates a cross-sectional SEM image of the same sample as in FIG. 2.1(c).

FIG. 2.2(a) illustrates normal-incidence specular reflection spectra obtained from a macroporous polymer film having 320 nm diameter air cavities exposed to ethanol vapors with different partial pressures. FIG. 2.2(b) illustrates the dependence of the wavelength shift of the Bragg diffraction peak vs. ethanol partial pressure.

FIG. 2.3(a) shows the calculated volume fractions of air and the corresponding adsorbed ethanol layer thickness at different ethanol partial pressures. FIG. 2.3(b) shows the simulated specular reflection spectra obtained from a macroporous polymer film having 320 nm cavities exposed to ethanol vapors with different partial pressures.

FIG. 2.4 illustrates the dependence of In

$$\frac{P}{{P}_{0}} vs .$$

the reciprocal of the radius of curvature of the condensed liquid films.

FIG. 2.5(a) illustrates the normal-incidence specular reflection spectra obtained from a macroporous polymer film having 320 nm air cavities exposed to water vapors with different partial pressures. FIG. 2.5(b) illustrates the dependence of the wavelength shift of the Bragg diffraction peak vs. water partial pressure.

FIG. 3.1 is a schematic illustration of the experimental setup for assembling large-area colloidal crystal-polymer nanocomposites by using a simple doctor blade coating technique.

FIGS. 3.2(A) to (F) illustrates the colloidal crystal-polymer nanocomposites fabricated by the doctor blade coating technique. FIG. 3.2(A) is a photograph of a multilayer nanocomposite having 290 nm diameter silica spheres embedded in an ethoxylated trimethylolpropane triacrylate (ETPTA) matrix coated on a glass substrate. FIG. 3.2(B) is a top-view SEM image of the sample in FIG. 3.2(A). The inset showing a Fourier transform of a 40 μm×40 μm region. FIG. 3.2(C) is a magnified SEM image of FIG. 3.2(B). FIG. 3.2(D) shows a pair correlation function (PCF) calculated from the SEM image in FIG. 3.2(B). For comparison, the PCF for an ideal lattice with hexagonal close-packed structure is also shown (black lines). FIG. 3.2(E) Top-view SEM image of a sample having 330 nm silica spheres embedded in an ETPTA matrix. FIG. 3.2(F) is a top-view SEM image of a nanocomposite having 290 nm silica spheres embedded in a polyethylene glycol (600) diacrylate (PEGDA) matrix. All samples were prepared by DB-coating 50 vol. % colloidal suspensions at a speed of 0.1 μm/s.

FIGS. 3.3(A) to (C) shows the thickness dependence of the DB-coated colloidal crystal-ETPTA nanocomposites on the coating speed and particle volume fraction for FIG. 3.3(A) 290 nm, FIG. 3.3(B) 330 nm, and FIG. 3.3(C) 560 nm silica spheres.

FIGS. 3.4(A) to (D) illustrates a macroporous polymer membrane after the selective removal of templating silica spheres. FIG. 3.4(A) is a photograph of a free-standing, macroporous ETPTA film templated from 290 nm silica spheres. FIG. 3.4(B) is a top-view SEM image of the sample in FIG. 3.4(A). FIG. 3.4(C) illustrates a magnified SEM image of FIG. 3.4(B). FIG. 3.4(D) illustrates a cross-sectional SEM image of the sample in FIG. 3.4(A). The sample was coated at a speed of 5 μm/s.

FIGS. 3.5(A) to (E) show separation of 10 nm gold nanoparticles from 330 nm silica spheres by using a free-standing, macroporous ETPTA membrane filter. FIG. 3.5(A) illustrates the experimental setup. FIG. 3.5(B) illustrates a photograph of the gold nanoparticle/silica spheres solution prior to filtration. FIG. 3.5(C) illustrates a photograph of the solution after filtration. FIG. 3.5(D) illustrates a TEM image of the solution in FIG. 3.5(B). FIG. 3.5 (E) illustrates a TEM image of the solution in FIG. 3.5(C).

FIG. 3.6(A) illustrates a normal-incidence optical reflection spectra of an ETPTA-silica colloidal crystal nanocomposite, a corresponding macroporous ETPTA film, and a released silica colloidal crystal with 290 nm spheres and 12 colloidal layers. The arrows indicate the expected positions of the peaks for each sample, calculated using Bragg's law at normal incidence. FIG. 3.6(B) illustrates a comparison of the experimental and Scalar Wave Approximation (SWA)-simulated optical reflection spectra at normal incidence from a macroporous ETPTA film templated from 290 nm silica spheres.

FIGS. 4.1(A) and (B) show the working principle of macroporous polymer reflective color displays. FIG. 4.1(A) illustrates that a macroporous polymer film exhibits shining green color. FIG. 4.1(B) illustrates that when the air cavities of macroporous polymer are filled with ethanol, the color becomes red and the sample is transparent. The underneath letters “UF” become visible.

FIG. 4.2 illustrates the optical reflection spectra showing the color change process when the cavities of macroporous polymer is gradually replaced by ethanol.

FIGS. 4.3(A) and (B) illustrate the protocol of a electrically driven reflective color display. FIG. 4.3(A) shows the power off and FIG. 4.3(B) shows the power on.

FIG. 4.4 illustrates that multi-color displays are feasible by fabricating macroporous polymer films with stacked air cavities of different sizes.

FIG. 4.5 illustrates the proof-of-concept experiment demonstrates the feasibility of constructing reflective color displays on curved surface.

FIG. 5.1 is a schematic illustration of the velocity profile and the pressure head (Δh) in the doctor blade coating process.

FIG. 5.2 shows relative viscosity of 330 nm silica spheres/ETPTA suspensions with different particle volume fractions at various shear rates.

FIG. 5.3 illustrates the cross-sectional SEM image of a silica colloidal crystal after removing ETPTA matrix by 10-min oxygen plasma etching.

FIG. 5.4(A) shows a comparison of the extinction spectra of the solutions in FIG. 3.5(A) and (B). FIG. 5.4(B) shows a calibration curve for calculating the concentration of gold nanoparticles in filtrate solutions.

FIG. 5.5(A) is a schematic illustration of the dual-blade setup. FIG. 5.4(B) is a photograph of a multilayer nanocomposite having 290 nm diameter silica spheres embedded in an ETPTA matrix aligned by a dual-blade system at a coating speed of 1 mm/s.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of environmental engineering, biology, chemistry, materials science, mechanical engineering, and the like, which are within the skill of the art. The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### Discussion

In accordance with the purpose(s) of the present disclosure, as embodied and broadly described herein, embodiments of the present disclosure, in one aspect, relate to porous polymer membranes, structures including porous polymer membranes, devices including porous polymer membranes, methods of using porous polymer membranes, methods of making porous polymer membranes, and the like.

An advantage of an embodiment of the present disclosure is that the process for making the porous polymer membranes is simple, scalable, and inexpensive and can produce an ordered array of voids in the porous polymer membrane. Some embodiments of the present disclosure can be used as filters to precisely (e.g., about ±10% of the size of the interconnecting windows (each area where the nanoparticle was removed (void)); the size distribution of these windows is about 10%) separate components based on size. Other embodiments of the present disclosure can be used as signs or displays. See Examples 1 to 4 for additional details.

In an embodiment, the porous polymer membrane includes an ordered array of voids. In an embodiment, the distance between at least two pairs of adjacent voids is substantially the same (e.g., about 0.03 micrometers to 10 micrometers). In an embodiment, the number of unique pairs can be about 10, 100, 1000, 10,000, 100,000, 1,000,000, 100,000,000, 100,000,000, to about 10, 100, 1000, 10,000, 100,000, 1,000,000, 100,000,000, 100,000,000, 1×10¹⁰, 1×10¹², 1×10¹⁵, 1×10¹⁷, or 1×10²⁰ and any set of ranges (e.g., about 10,000 to 100,000, about 100 to 1×10¹⁰, etc.) within these numbers or subranges (e.g., about 15 to 200,000, 2,500,000 to 3×10¹², etc.) within these numbers.

In an embodiment, the distance between each pair of adjacent voids is substantially the same. In an embodiment, the distance between a portion of the pairs of adjacent voids is substantially the same. In an embodiment, the “portion” can be about 50% or more, about 60% or more, about 70% or more, about 80% or more, about 90% or more, about 99% or more, or about 100%, over a defined area of the porous polymer layer. In an embodiment, the defined area can include about 50% or more, about 60% or more, about 70% or more, about 80% or more, about 90% or more, about 95% or more, about 99% or more, or about 100%, of the area of the porous polymer layer. The term “substantially” in these contexts can mean about 50% or more, about 60% or more, about 70% or more, about 80% or more, about 90% or more, about 99% or more, or about 100%. The term “adjacent” refers to two voids next to one another without a void separating them in the same porous polymer membrane.

In an embodiment, a polymer framework separates the voids. In an embodiment a portion (as defined above) of the voids in a defined area extend the entire thickness of the porous polymer membrane (e.g., about 1 micrometer to 300 micrometers) to form a channel through the porous polymer membrane. In an embodiment, the diameter of substantially all of the voids can be substantially equivalent. In an embodiment, the diameter is about 0.03 micrometers to 10 micrometers. The term “substantially” in this context can mean about 50% or more, about 60% or more, about 70% or more, about 80% or more, about 90% or more, about 99% or more, or about 100%.

In an embodiment, two sets of voids of different diameters can be present that form an ordered array of voids. In an embodiment, a first set of a pair of voids has a first diameter and a second set of a pair of voids has a second diameter, where the first diameter and the second diameter are not the same. The ordered array of voids can have a plurality of first sets and second sets. In another embodiment, the porous polymer membrane can include three or more sets of such voids each having different diameters.

In an embodiment, the porous polymer membrane is formed by disposing a monomer/nanoparticle mixture on a surface. The monomer/nanoparticle mixture can include one or more types of monomers and/or one or more types of nanoparticles, and/or one or more sizes of nanoparticles. In an embodiment, the mixture can be formed on the surface by adding the monomer and nanoparticles sequentially or simultaneously. Additional details regarding the monomers and nanoparticles are described herein. The monomer/nanoparticle can be disposed on a surface using a process such as a doctor blade coating process, tape casting, or applying a simple shear force by two plates with a controlled gap in between. The nanoparticles can be aligned in a three dimensional ordered colloidal array, e.g., the particles can be located in crystalline lattices of, for example, a face-centered cubic (f.c.c.), hexagonal-centered cubic (h.c.p.) crystals, or the like. Once the monomer/nanoparticle is disposed on the surface, the monomer can be polymerized to form a polymer membrane having nanoparticles disposed in the polymer membrane. In an embodiment, the polymerization can be photopolymerization, thermopolymerization, or a combination thereof.

Subsequently, a portion (e.g., about 50%, 60%, 60%, 80%, 90%, 95%, 99% or more, or about 100%) or all of the nanoparticles can be removed to form the porous polymer membrane. In an embodiment, the nanoparticles can be removed by a process that does not alter the polymer. The type of process used to remove the nanoparticles depends, at least in part, upon the type of nanoparticle and the polymer. In an embodiment, the porous polymer membrane is formed by dissolving the nanoparticles using an acid solution such as, but not limited to, hydrofluoric acid (e.g., for silica nanoparticles). Once the nanoparticles are removed, the porous polymer membrane can be removed from the surface.

As mentioned above, the voids are made from the removal of one or more nanoparticles. In an embodiment, the nanoparticles are disposed on top (e.g., directly or offset but still contacting the nanoparticle above and/or below so a channel is formed) of one another in the polymer membrane, and when the nanoparticles are removed, a void is formed so that a channel through the porous polymer membrane is present. In an embodiment, the channel does not have a uniform diameter, but has an average diameter of about 0.03 micrometers to 10 micrometers.

In an embodiment the material to form the monomer can include a thermopolymer, a photopolymer, or a combination thereof. In an embodiment, the thermopolymer can be selected from: polystyrene, polyurethane, polydimethylsiloxane, or a combination thereof. In an embodiment, the photopolymer can be selected from: polyacrylates, poly(methacrylates), polystyrene, or a combination thereof. The polymer matrix needs to be stable during the removal of the templating nanoparticles. Highly cross-linked polymers (i.e., monomer has more than 2 cross-linkable functional groups) are preferred.

Once the monomer is polymerized, a polymer framework is formed around the nanoparticles. After the nanoparticles are removed, the polymer framework supports the porous polymer membrane. The dimensions of the polymer framework can be controlled by the process of disposing the monomer/nanoparticle mixture on the substrate. In an embodiment, the thickness of the polymer framework between adjacent nanoparticles is about 0.03 micrometers to 10 micrometers. Additional details are provided in Examples 1-4.

The nanoparticles can be of the same or different type and/or same or different size, depending on the use or purpose of the porous polymer membrane. The selection of the type nanoparticle can depend upon the process for removing the nanoparticle, the type of polymer, and/or polymer framework. The selection of the size can depend upon the process for removing the nanoparticles, the type of polymer, the polymer framework, the diameter of the desired voids and channel, and the like. In an embodiment, two or more different types and/or sizes of nanoparticles can be selected. In an embodiment, two or more processes can be used to remove nanoparticles (e.g., when two or more types of nanoparticles are used in the monomer/nanoparticle mixture). The type of nanoparticle can include silica nanoparticles, polymer latex nanoparticles, titania nanoparticles, CdSe nanoparticles, and other nanoparticles where the type selected has a uniform diameter. In an embodiment, the nanoparticles can have a diameter of about 0.03 to 10 micrometers.

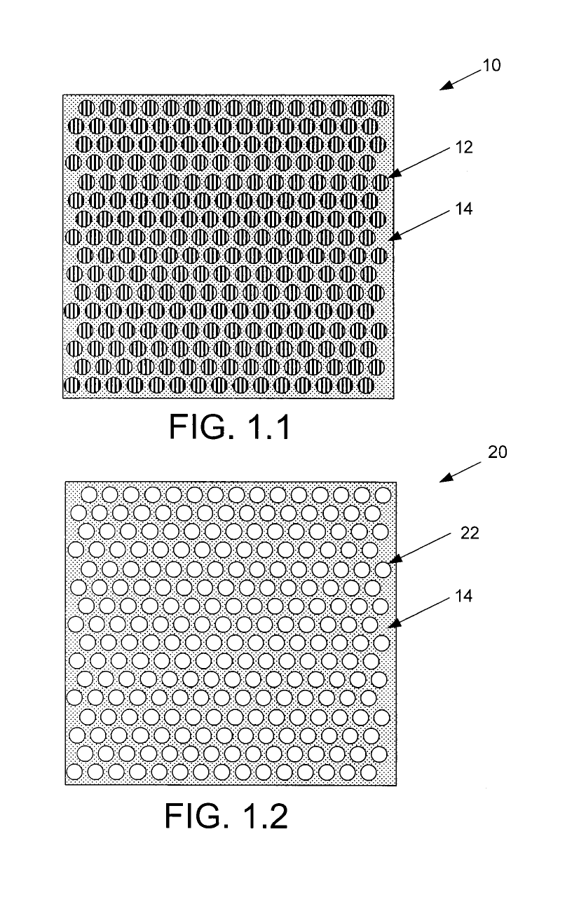

FIG. 1.1 illustrates a polymer membrane 10 including the nanoparticles 12 and the polymer framework 14. FIG. 1.2 illustrates a porous polymer membrane 20 having voids 22, where the nanoparticles 12 were previously disposed.

In an embodiment, the porous polymer membrane can be included in a structure that can be used as a filter. In an embodiment, the filter can separate components having a diameter of about 0.1 micrometers to 3 micrometers. The filter can be of a large or small area and can have well defined void sizes and/or size distributions. The selection of the nanoparticles can be based on the components to be separated. In other words, different types of filters can be designed by selection of the diameter of the nanoparticles based on the intended use of the filter to separate certain sized components. In an embodiment, two or more types (e.g., having different diameter pores) of porous polymer membranes can be stacked on top of one another and used as a filter.

In an embodiment, the porous polymer membrane can be included in a device that can be used as a display or a sign. The device can include one or more structures including the porous polymer membrane. In an embodiment, one or more addressable portions of the first structure are independently in fluidic communication with a fluid (e.g., having the same refractive index as the polymer) moving structure (hereinafter “fluid structure”). The fluid structure is adapted for moving a fluid(s) (e.g., alcohol, water, toluene, or a combination thereof) into and out of a portion of the voids of the first structure. In an embodiment, the fluid structure can move a first fluid into or out of a portion of the porous polymer membrane independently of moving a second fluid into or out of another portion of the porous polymer membrane. The first fluid and the second fluid can be the same or different fluids. In an embodiment, the fluid can be colored. In an embodiment, the fluid structure uses heat and/or pressure to control the movement of the fluid into and out of a portion of the voids.

In an embodiment, the fluid structure can be an indium tin oxide coated glass that can heat the fluid to cause the fluid to move into and out of the voids. Specifically, the first structure is disposed on the indium tin oxide coated glass, where a material (e.g., polydimethylsiloxane (PDMS)) can be disposed between the first structure and the indium tin oxide coated glass. See Examples 1 to 4 for additional information.

In an embodiment, a portion of the first structure has a first color when the fluid is within the void and a second color when the void does not include any fluid. The first color and the second color can be any known color (non-transparent) or can be transparent. Thus, the color of the display or sign can be controlled by moving fluid into or out of the certain voids to present or remove words, figures, pictures, or the like. In an embodiment, a word, figure, or picture can be positioned behind the first structure, so that if the first color is a non-transparent color and the second color is transparent, the word, figure, or picture can be displayed when a portion of the void does not include any fluid, e.g., the portion of the porous polymer membrane is transparent.

In another embodiment, the device can include two or more structures including the porous polymer membrane. Each of the structures can be in fluid communication with one or more fluid structures and each fluid structure can operate in a similar manner as described above. For example, a first structure including a first porous polymer membrane can be disposed on a first side of a fluid structure and a second porous polymer membrane can be disposed on a second side of the first structure. The fluid structure can move fluid into and out of portions of each of the first and second porous polymer structures.

### EXAMPLES

Now having described the embodiments of the present disclosure, in general, examples 1-4 describe some additional embodiments of the present disclosure. While embodiments of the present disclosure are described in connection with examples 1-4 and the corresponding text and figures, there is no intent to limit embodiments of the present disclosure to these descriptions. On the contrary, the intent is to cover all alternatives, modifications, and equivalents included within the spirit and scope of embodiments of the present disclosure.

Example 1

Mesoporous membranes, such as 2-D porous silicon and 1-D titania photonic crystals, have been widely used in sensitive vapor detection.¹⁻¹⁴ By monitoring the change of the optical properties (e.g., wavelength shift of the photonic band gaps or the Fabry-Perot fringes) of the diffractive media during vapor condensation, the concentration of the vapors can be deduced. Blue-colored Morpho butterfly wing scales, which are intrinsic 3-D photonic crystals exhibiting unique optical diffraction and interference, have also been demonstrated for highly selective vapor detection.¹⁵ However, the limited size and material selection of these natural photonic crystals impede the development of reproducible and reusable vapor detectors. In this example it is shown that 3-D macroporous polymer photonic crystals created by an inexpensive and scalable bottom-up technology enable the rapid and reversible detection of a wide range of vapors ranging from water to toluene. The capillary condensation of vapors in the submicrometer-scale macropores, a topic that has received little examination,¹⁶⁻¹⁹ has also been investigated by both experiments and theoretical calculations.

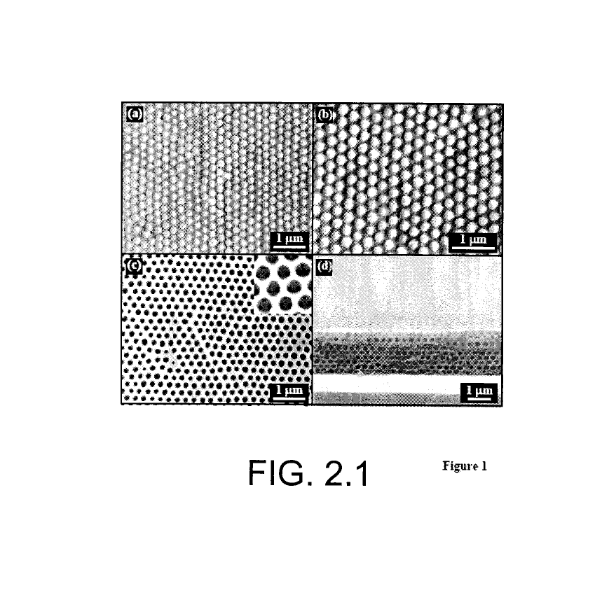

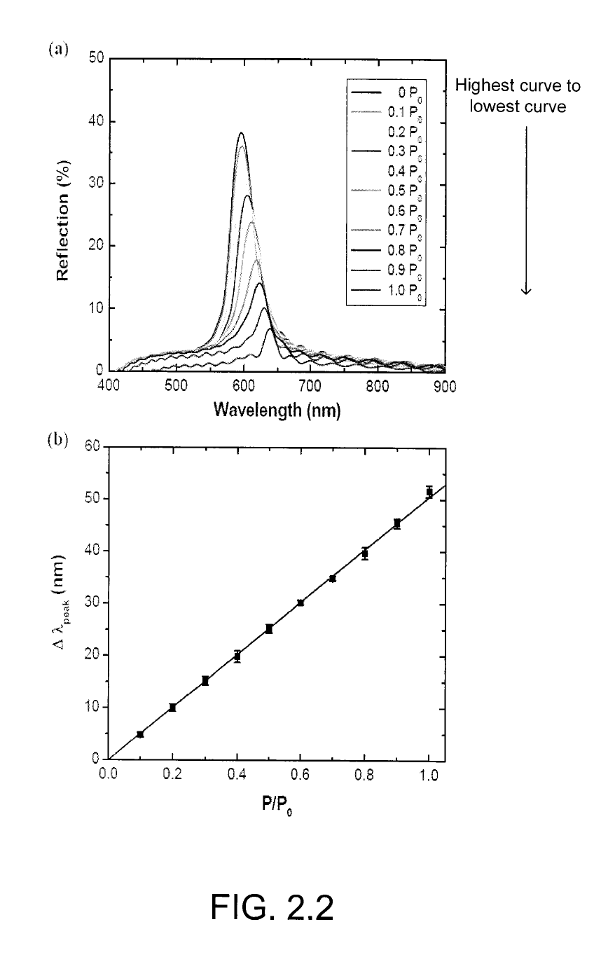

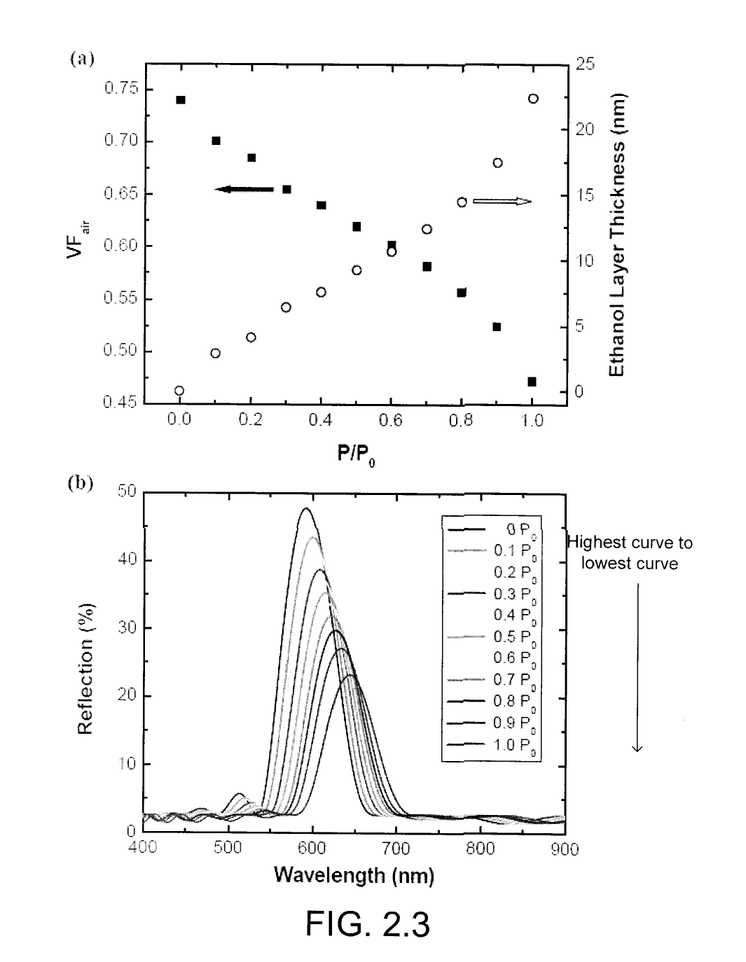

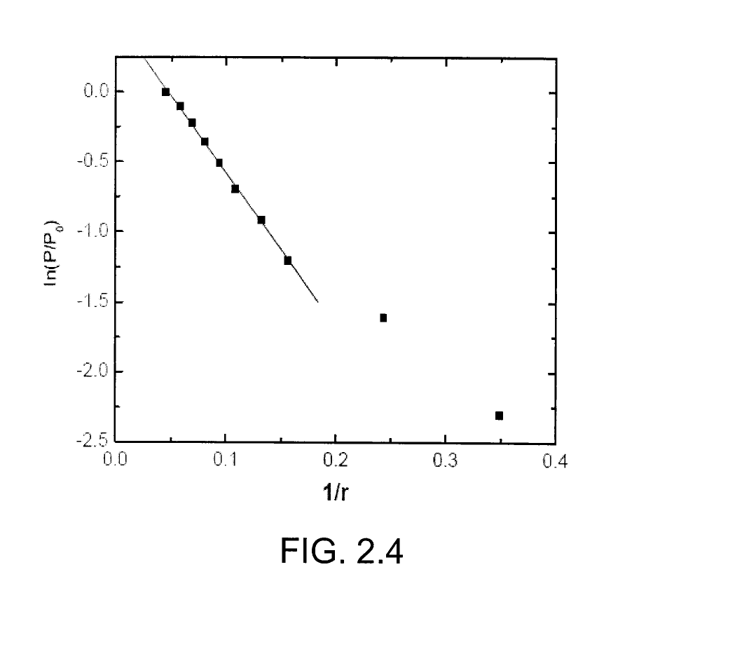

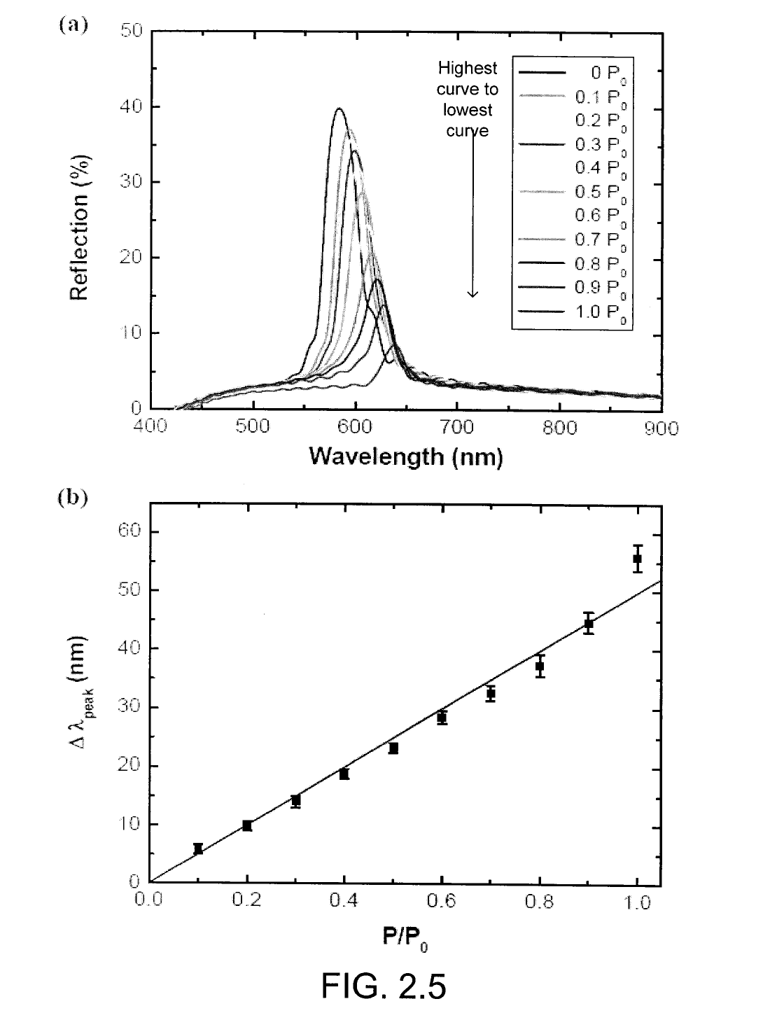

Macroporous polymer photonic crystals with 3-D crystalline arrays of voids are fabricated by the scalable doctor blade coating (DBC) technology.²⁰ FIGS. 2.1(a) and 2.1(b) show typical top-view scanning electron microscope (SEM) images of a DB-coated silica colloidal crystal-ethoxylated trimethylolpropane triacrylate (ETPTA) polymer nanocomposite having 320 nm silica microspheres. The long-range hexagonal ordering of the colloidal crystal is clearly evident. The embedded silica microspheres can then be completely removed by etching in a 2 vol. % hydrofluoric acid aqueous solution. After drying, the resulting self-standing macroporous polymer films exhibit uniform and shining colors caused by Bragg diffraction of visible light from 3-D highly ordered air cavities (FIGS. 2.1(c) and 2.1(d)). Importantly, the large air cavities are interconnected through smaller windows (inset of FIG. 2.1(c)) which are originated from the touching sites of the close-packed silica microspheres in the shear-aligned nanocomposite.²¹

The templated macroporous polymer film is placed in a home-made environmental chamber. The chamber is evacuated and then back-filled with a vapor with a specific pressure. Dry nitrogen is used to control the total pressure of the chamber to be 1 atm. An Ocean Optics visible-near-IR spectrometer with a reflection probe is used for normal-incidence specular reflectance measurements. Absolute reflectivity is obtained as ratio of the sample spectrum and the reference spectrum, which is the optical density obtained from an aluminum-sputtered (1000 nm thickness) silicon wafer. Final value of the absolute reflectivity is the average of several measurements obtained from different spots on the sample surface.

FIG. 2.2(a) shows the normal-incidence specular reflectance spectra obtained from a macroporous ETPTA film with 320 nm air cavities exposed to ethanol vapors with different partial pressures (from 0 P₀ to 1.0 P₀) at 55±1° C. P₀ is the saturation vapor pressure of ethanol at this temperature (280 mmHg).²² All spectra display distinct Bragg diffraction peaks with well-defined Fabry-Perot fringes, indicating high crystalline quality of the self-assembled macroporous photonic crystal. When the partial pressure of ethanol vapor is increased, ethanol condensates in the air cavities of the macroporous film, leading to a higher effective refractive index of the diffractive medium and a smaller dielectric contrast between the polymer and the enclosed materials. This explains the observed red-shift of the Bragg diffraction peaks and the reduction of the amplitude of the optical stop bands as shown in FIG. 2.2(a). FIG. 2.2(b) indicates that the shift of the diffraction peaks (compared to the sample exposed to pure nitrogen gas) is nearly linear with respect to the ethanol partial pressure. By monitoring the time dependence of specular reflectance spectra at difference vapor partial pressures and temperatures, the speed of response (i.e., time to reach equilibrium) of photonic crystal vapor detectors is determined to be less than 1 min. The optical properties of the macroporous polymer films are fully recovered when the condensed ethanol is evaporated. The photonic crystal films can thus be reused many times for reproducible vapor detection.

To gain a better understanding of vapor condensation in templated macroporous films, we calculate the amount of condensed ethanol at different vapor partial pressures by using the Bragg diffraction equation: λₘₐₓ=2×n_{eff}×d×sin θ, where n_{eff} is the effective refractive index of the diffractive medium, d is the inter-plane distance, and θ is π/2 for normal incidence. By assuming the templated air cavities are close-packed and the volume fraction (VF) of air in a dry macroporous polymer film is 0.74, the effective refractive index of the medium can be calculated as: n_{eff}=n_{ETPTA}×0.26+nₐᵢᵣ×VFₐᵢᵣ+n_{EtOH}×(0.74−VFₐᵢᵣ), where n_{ETPTA}, nₐᵢᵣ, and n_{EtOH} are 1.46, 1.0, and 1.36, respectively. The calculated volume fractions of the remaining air (VFₐᵢᵣ) in the macroporous film at different ethanol partial pressures are shown in FIG. 2.3(a).

If we assume the condensed ethanol forms a uniform thin liquid layer on the walls of the polymer voids, the thickness of this ethanol layer can be calculated by using the volume fraction of the condensed ethanol (0.74−VFₐᵢᵣ). The results in FIG. 2.3(a) show that a 22.4 nm liquid layer can be formed on the walls of 320 nm voids when the macroporous film is exposed to a saturated ethanol vapor. The calculated ethanol layer thickness is then incorporated in the scalar wave approximation (SWA) model²³⁻²⁴ developed for periodic dielectric structures to quantitatively simulate the specular reflectance spectra at different vapor partial pressures. Although the simulated spectra (FIG. 2.3(b)) exhibit higher reflectance than the experimental results (FIG. 2.2(a)), the shape, position, red-shift, and amplitude reduction of the diffractive peaks associated with the condensation of ethanol in the voids of the macroporous photonic crystal agree well with the experiments.

We attribute the condensation of ethanol vapor in the macroporous photonic crystals to capillary condensation. The Kelvin equation, In

$$\frac{P}{{P}_{0}} = - \frac{2 γ {V}_{l}}{rRT} ,$$

where P and P₀ are actual and saturation vapor pressure, γ is the liquid/vapor surface tension, V₁ is the liquid molar volume, r is the radius of curvature, can be used to describe the phenomenon of capillary condensation due to the presence of a curved meniscus.¹⁸⁻¹⁹ In macroporous films, the radius of curvature of the condensed liquid film equals to the radius of the air cavity minus the liquid film thickness. Thus a higher vapor partial pressure leads to a smaller r (i.e., a thicker liquid layer). In addition, as γ, V₁, R and T are all constants at a fixed temperature, In

$$\frac{P}{{P}_{0}}$$

is inversely proportional to r. FIG. 2.4 shows that this prediction agrees well with experimental results when the liquid layer is relatively thick. A thinner liquid layer formed at a low vapor partial pressure might not be continuous and this could explain the large deviation of the two data points in FIG. 2.4.

The macroporous photonic crystal-based vapor detection can be easily extended to a large variety of vapors, such as toluene and water. FIG. 2.5 shows that the response of water detection is quite familiar with that of ethanol detection. It is noteworthy to mention that a bulk liquid water droplet cannot penetrate into the voids of a templated macroporous ETPTA film due to a large water contact angle of 78±3°.

Above we have shown that macroporous photonic crystal-enabled vapor detectors can sense vapors at both high and low concentrations. The flexible macroporous polymer membranes, which can be scalably and economically produced over large areas by the doctor blade coating technology, could be applicable as low-cost, portable colorimetric vapor sensors (e.g., humidity sensors) at relatively high concentrations. To increase the sensitivity of the templated macroporous vapor detectors at low concentration, the full-spectrum analysis technique,²⁵ which considers both the shift of the optical stop bands and the change of the spectral amplitude, can be applied. To enhance the selectivity for mixtures of vapors, the polymer surface can be selectively modified or hierarchical structures (e.g., multiple layers with each layer responding to a specific vapor) can be explored.¹⁵

In summary, we have demonstrated that macroporous photonic crystals created by a continuous and scalable doctor blade coating process can be used directly for vapor detection. The capillary-condensed vapor forms a liquid layer covering the surface of the submicrometer-scale macropores.

### REFERENCES, EACH OF WHICH IS INCORPORATED HEREIN BY REFERENCE

1. L. De Stefano, L. Moretti, A. Lamberti, O. Longo, M. Rocchia, A. M. Rossi, P. Arcari and I. Rendina, IEEE Trans. Nanotechnology 3, 49 (2004).
2. T. Endo, Y. Yanagida and T. Hatsuzawa, Sens. Actuators B 125, 589 (2007).
3. X. Y. Fang, V. K. S. Hsiao, V. P. Chodavarapu, A. H. Titus and A. N. Cartwright, IEEE Sens. J. 6, 661 (2006).
4. N. Hidalgo, M. E. Calvo, S. Colodrero and H. Miguez, IEEE Sens. J. 10, 1206 (2010).
5. T. Hutter and S. Ruschin, IEEE Sens. J. 10, 97 (2010).
6. T. Karacali, M. Alanyalioglu and H. Efeoglu, IEEE Sens. J. 9, 1667 (2009).
7. B. H. King, A. Gramada, J. R. Link and M. J. Sailor, Adv. Mater. 19, 4044 (2007).
8. B. H. King, A. M. Ruminski, J. L. Snyder and M. J. Sailor, Adv. Mater. 19, 4530 (2007).
9. J. Kobler, B. V. Lotsch, G. A. Ozin and T. Bein, ACS Nano 3, 1669 (2009).
10. I. A. Levitsky, W. B. Euler, N. Tokranova and A. Rose, Appl. Phys. Lett. 90, 041904 (2007).
11. V. S. Y. Lin, K. Motesharei, K. P. S. Dancil, M. J. Sailor and M. R. Ghadiri, Science 278, 840 (1997).
12. A. M. Ruminski, M. M. Moore and M. J. Sailor, Adv. Funct. Mater. 18, 3418 (2008).
13. H. Saha and C. Pramanik, Mater. Manufact. Proc. 21, 239 (2006).
14. M. S. Salem, M. J. Sailor, F. A. Harraz, T. Sakka and Y. H. Ogata, J. Appl. Phys. 100, 083520 (2006).
15. R. A. Potyrailo, H. Ghiradella, A. Vertiatchikh, K. Dovidenko, J. R. Cournoyer and E. Olson, Nat. Photon. 1, 123 (2007).
16. S. J. Gregg and K. S. W. Sing, Adsorption, Surface Area and Porosity, 2nd ed. (Academic Press Inc., London, 1982).
17. B. Coasne, A. Grosman, C. Ortega and M. Simon, Phys. Rev. Lett. 88, 256102 (2002).
18. L. R. Fisher, R. A. Gamble and J. Middlehurst, Nature 290, 575 (1981).
19. Z. Gemici, P. I. Schwachulla, E. H. Williamson, M. F. Rubner and R. E. Cohen, Nano Lett. 9, 1064 (2009).
20. H. T. Yang and P. Jiang, Langmuir 26, 13173 (2010).
21. A. Blanco, E. Chomski, S. Grabtchak, M. Ibisate, S. John, S. W. Leonard, C. Lopez, F. Meseguer, H. Miguez, J. P. Mondia, G. A. Ozin, O. Toader and H. M. van Driel, Nature 405, 437 (2000).
22. D. R. Lide and H. P. R. Frederikse, CRC Handbook of Chemistry and Physics, 76th ed. (CRC Press, Boca Raton, Fla., 1995).
23. Z. Zhang and S. Satpathy, Phys. Rev. Lett. 65, 2650 (1990).
24. J. F. Bertone, P. Jiang, K. S. Hwang, D. M. Mittleman and V. L. Colvin, Phys. Rev. Lett.

83, 300 (1999).
25. J. Maria, T. T. Truong, J. Yao, T. W. Lee, R. G. Nuzzo, S. Leyffer, S. K. Gray, J. A. Rogers, J. Phys. Chem. C 2009, 113, 10493.

### Example 2

Membrane filters are widely utilized in a large variety of separation applications, such as water treatment, pollution removal, filtration of aqueous solutions (such as cell culture media, serum, enzyme and water), removal of bacteria and debris, filtration of organic solutions, and so on. They are also routinely used in chemical, biological, medical, and agricultural laboratories. One important parameter that controls the separation efficiency is the pore size and size distribution of the membrane filters. Filters with nanometer-scale pore size and tight size control, are very useful in biological separation (e.g., removal of viruses). Heavy ion track etching is a commercial technology for producing membrane filters with well-defined pore size, shape, and density. However, heavy ion accelerators are required to create such filters and the fabrication cost is high. In this disclosure, we disclose a much economic and scalable nanomanufacturing technology for creating large-area filtration membranes with well-defined pore sizes (in the nanometer-scale) and size distribution. No significant equipment investment is required and the technology is roll-to-roll processable. We anticipate the technology will significantly reduce the production cost of membrane filters.

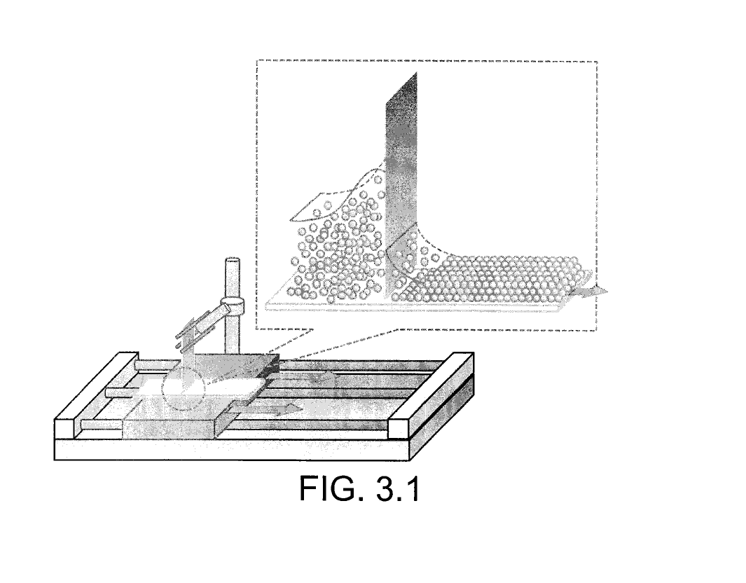

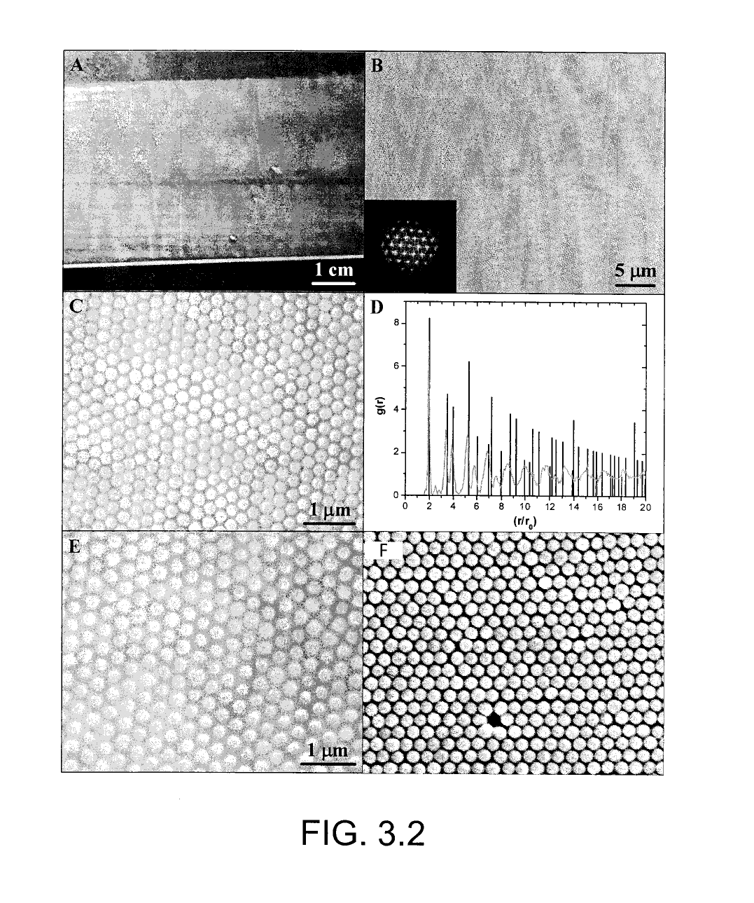

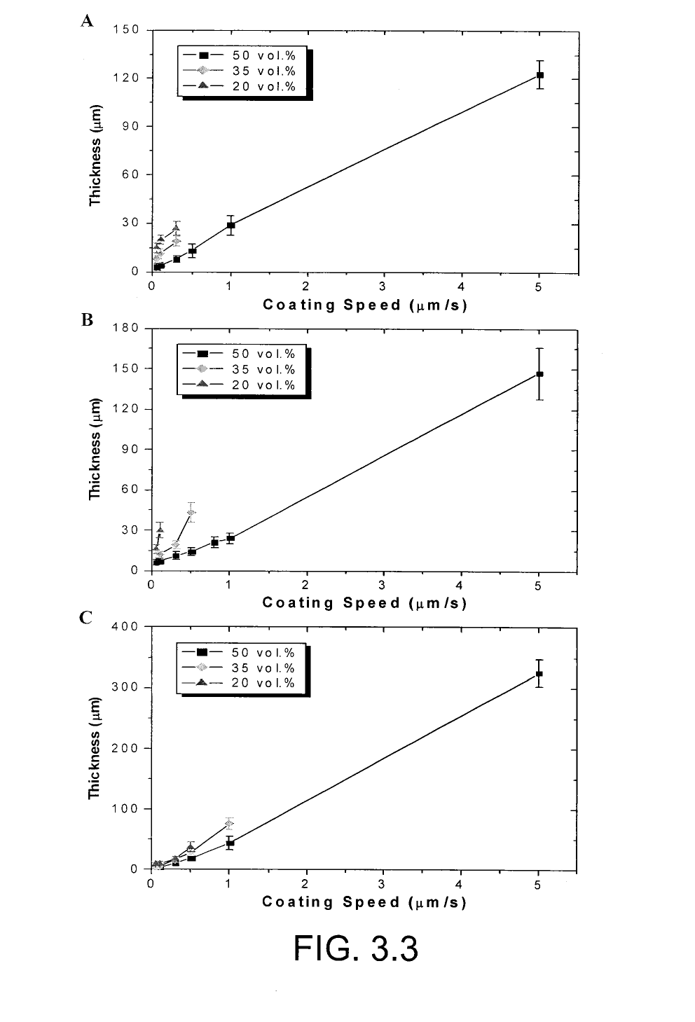

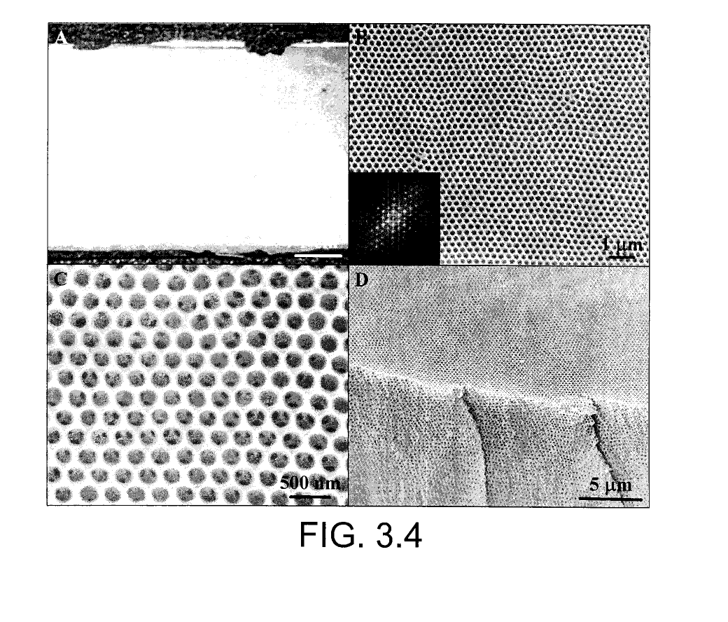

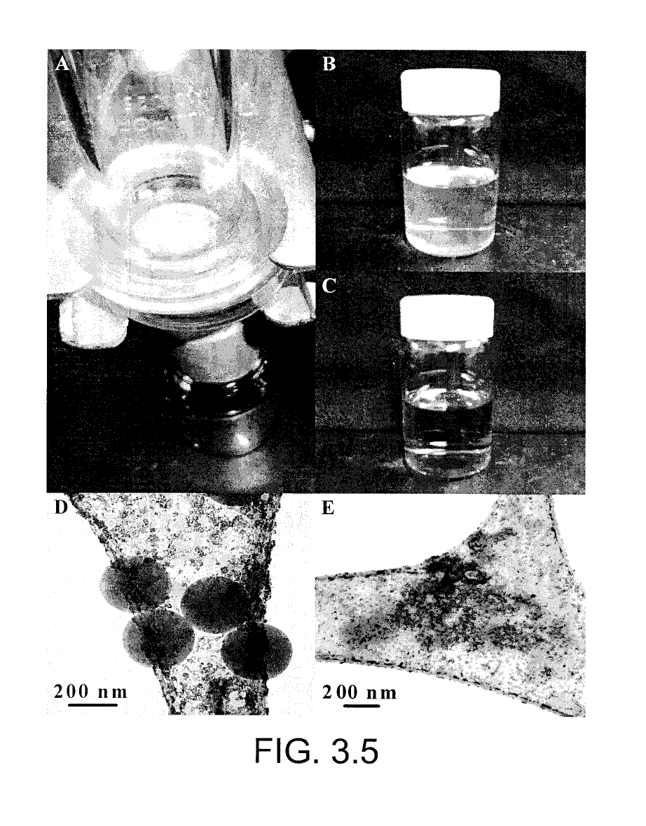

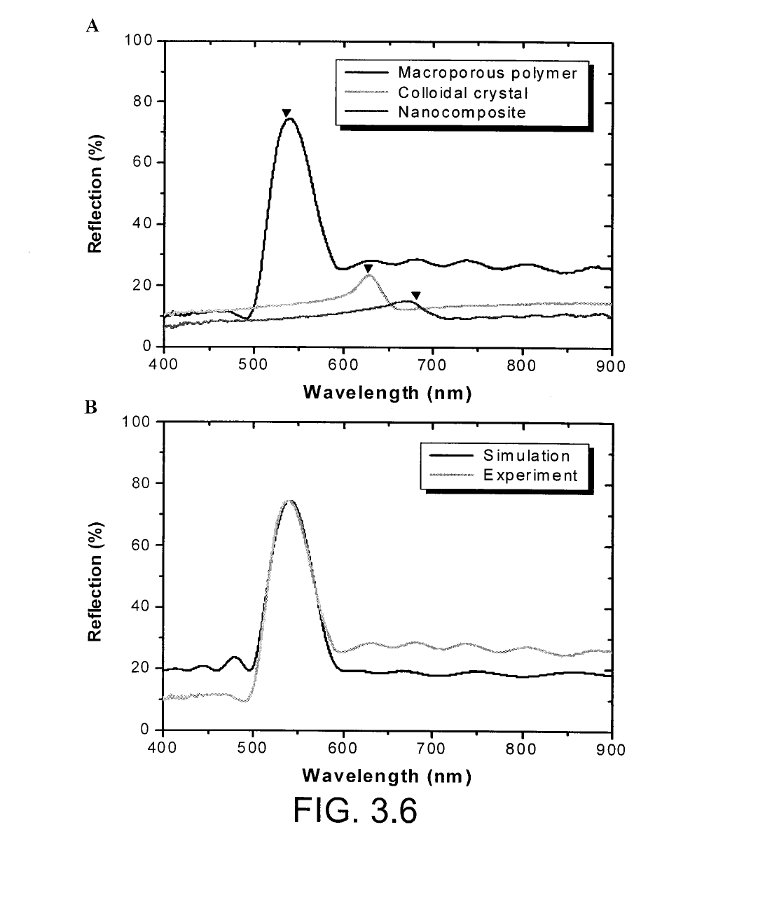

The disclosed embodiment is based on colloidal self-assembly and templating nanofabrication. A schematic illustration of the technology is shown in FIG. 3.1. We first assemble uniform silica microspheres (commercially available) dispersed in a monomer using a doctor blade coating (DBC) process. DBC technology has been widely used in printing and coating industries for making large-area films with uniform thickness. A commercial doctor blade is placed vertically on the surface of a substrate (e.g., glass, silicon, plastics). The silica microsphere/monomer dispersion is disposed between the substrate and the doctor blade. The substrate can be dragged in a controlled speed to move the colloidal suspension across the gap between the doctor blade and the substrate. A unidirectional shear force will then be applied to the colloidal suspension and the silica microspheres can be aligned into 3-D highly ordered colloidal arrays. The momoner is then photopolymerized by exposure to ultraviolet light. FIG. 3.2 shows the long-range ordering of the resulting colloidal arrays produced by the disclosed technology. FIG. 3.3 shows that the thickness of the resulting silica-polymer nanocomposites can be easily controlled by tuning the coating speed and the concentration of silica microspheres in the colloidal suspensions.

The silica microspheres in the shear-aligned nanocomposites can be selectively removed by dissolving in a 2 wt. % hydrofluoric acid aqueous solution. This results in the formation of self-standing macroporous membrane filters as shown in FIG. 3.4. From FIG. 3.4C, it is clear that the large pores which are templated from the silica microspheres are interconnected through small, nanometer-scale voids. These uniform voids are defined by the connected points between neighboring silica microspheres in the aligned nanocomposites.

We have demonstrated the separation efficiency of the templated macroporous membrane filters by separating 20 nm gold nanoparticles from 330 nm silica particles as shown in FIG. 3.5. This very rough proof-of-concept demonstration shows that almost all large silica particles have been filtered out and the collection efficiency of gold nanoparticles is higher than 85%.

Besides separation applications, the templated macroporous membranes can also be used for optical applications, such as optical filters, heat-pipe-inspired flat-panel displays, and thin-film coatings for smart windows. The Bragg-diffraction of visible light from the 3-D highly ordered void arrays as shown in FIG. 3.4 is the reason for the iridescent colors of the macroporous membranes (see FIG. 3.4A). Optical reflection measurements (FIG. 3.6) show that the macroporous membranes exhibit distinct reflection peaks matching with those predicted by a theoretical model.

In summary, we have developed a simple yet scalable nanomanufacturing technology for producing macroporous membrane filters with well-controlled pore size and size distribution. The doctor blade technology is compatible with roll-to-roll fabrication process for fabricating macroporous filters in industrial scale. The templated macroporous filters also exhibit unique optical diffraction properties that are promising for a spectrum of optical applications.

### Example 3

There is a big market for the low-end color displays, such as those widely used in supermarkets, signs, roadside advertisement etc. These displays are not competing with high-end products, such as flat-panel displays. They do not need very fast response time and the resolution requirement is also relatively low. However, they need to be fabricated in very large area (meters-scale) and in a low cost.

Some approaches have been explored to developed next-generation low-end color displays. Organic light-emitting diodes (OLEDs) based displays have been proposed for low-end products. However, the cost and manufacturing process are still expensive. Hewlett-Packard is developing novel reflective color displays based on colorful metal nanoparticles using the so-called surface-plasmon effect. Unfortunately, the low-cost fabrication over large areas is questionable.

Here we disclose a new methodology in creating reflective color displays by using macroporous polymers which can be created by a simple, inexpensive, and roll-to-roll compatible fabrication technology. Heat pipe technology which has been extensively used in dissipating heat for computer chips, solar cells, space shuttles, and Tran-Alaska Pipeline System. A heat pipe is a heat transfer mechanism that combines the principles of both thermal conductivity and phase transition to efficiently manage the transfer of heat between two solid interfaces. At the hot interface within a heat pipe, a liquid in contact with a thermally conductive solid surface turns into a vapor by absorbing the heat of that surface. The vapor condenses back into a liquid at the cold interface, releasing the latent heat. The liquid then returns to the hot interface through either capillary action or gravity action where it evaporates once more and repeats the cycle.

In our technology, we use macroporous polymer with 3-D highly ordered air cavities (see FIG. 3.4) as display elements. These macroporous films can be fabricated in very large areas (up to meters wide and long) by an inexpensive and roll-to-roll compatible doctor blade coating (DBC) technology. DBC technology (like newpaper printing) has been widely used in printing and coating industries for making large-area films with uniform thickness.

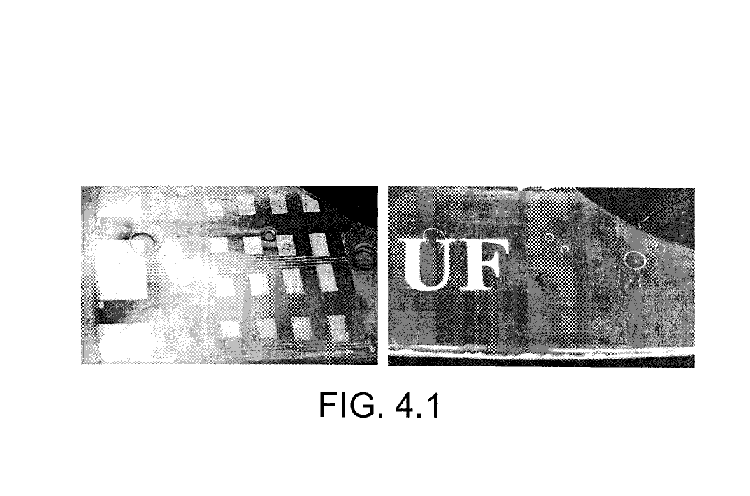

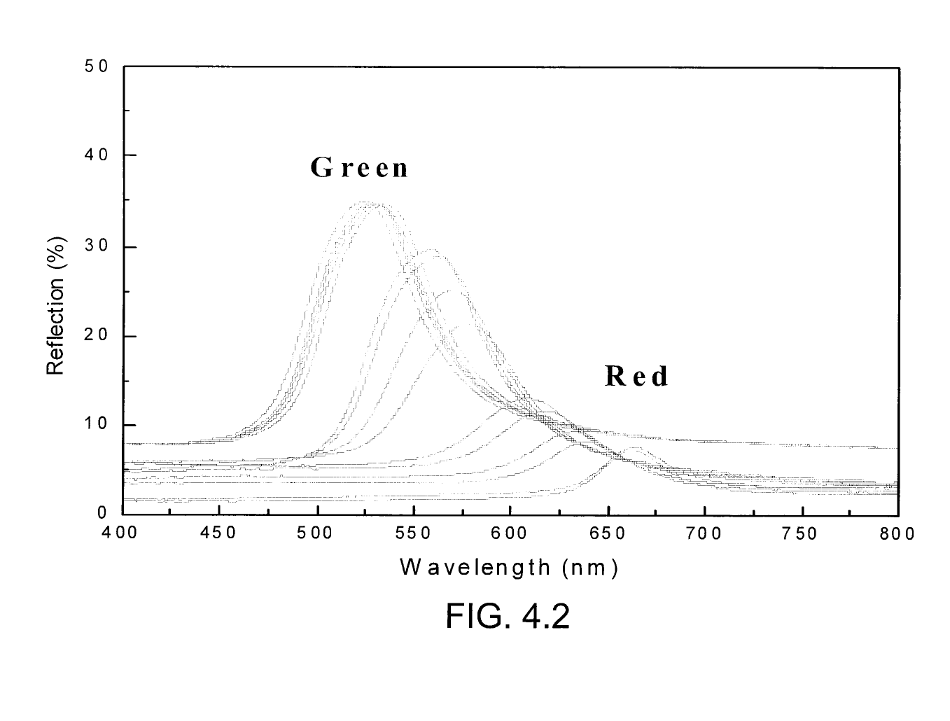

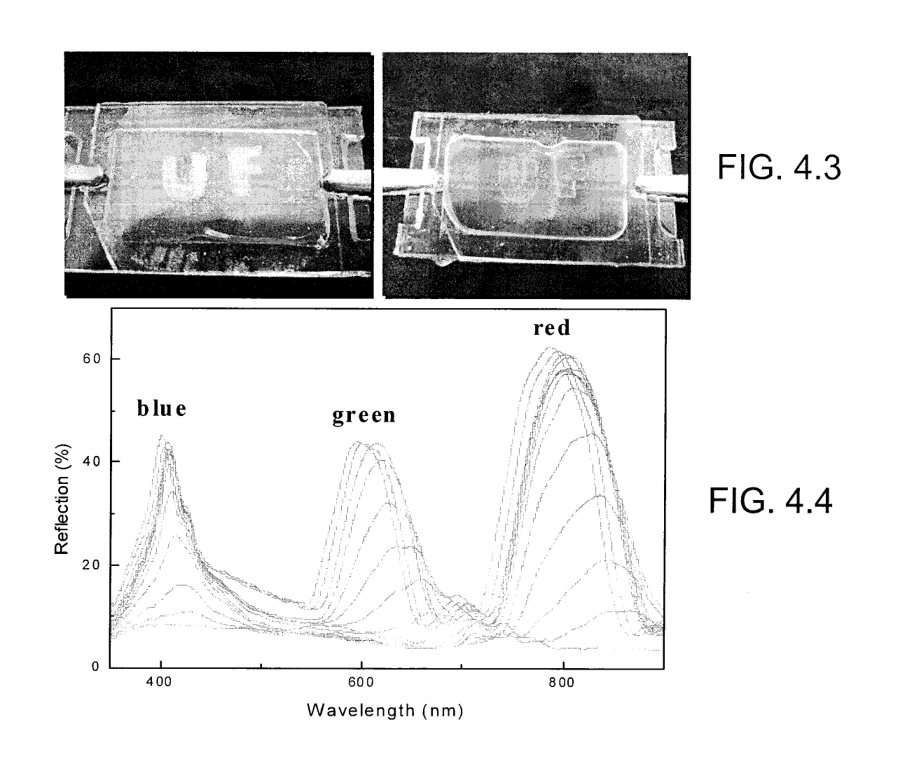

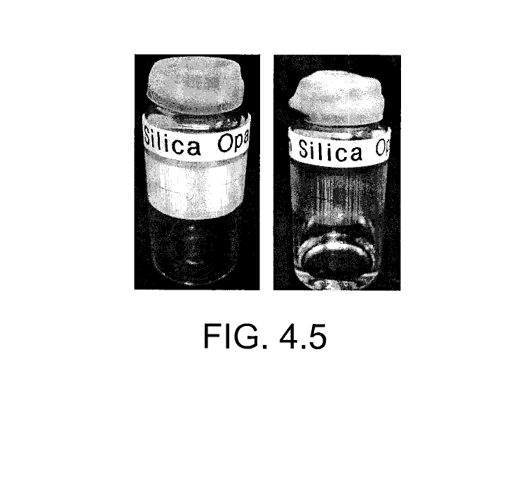

The self-standing macroporous polymer films exhibit brilliant colors which originate from the Bragg diffractive of visible light form the 3-D highly ordered air cavities. The colors can be easily changed by tuning the size of the air cavities to cover the whole visible spectrum. This indicates that all-color displays are possible. When the air cavities are filled with a solvent which has the same refractive index as that of the polymer, the macroporous polymer films becomes completely transparent due to the index matching. FIG. 3.4A shows a green-color macroporous polymer sample. When the air cavities are filled with ethanol (refractive index of ethanol is close to that of the polymer), the sample changes color to red and becomes transparent (the letters “UF” underneath the sample is visible). When ethanol is evaporated by in-situ heating, the sample color changes back to green. This process is highly reversible and reproducible for thousands of cycles. FIG. 4.2 shows the optical reflection spectra during the color change process.

To achieve in-situ heating and cooling for making real devices, we construct a protocol as shown in FIG. 4.3 by using indium tin oxide (ITO) coated glass as heating element. Applying a low voltage (1-2 V) for several seconds is sufficient to achieve ˜70° C. to evaporate ethanol which is filled between the top macroporous polymer and the ITO-glass substrate. A thin polydimethylsiloxane (PDMS) space is used in between. When power is on, ethanol is rapidly evaporated. The air cavities in macroporous polymer are then replaced with ethanol and sample becomes transparent. When the voltage is turned off, ethanol filled in the cavities of macroporous polymer evaporates as the vapor pressure of ethanol at room temperature is low. The macroporous polymer becomes highly shining.

We can also fabricate multi-color displays by creating macroporous polymer films with stacked air cavities with different sizes that reflect different colors (e.g., red, green, blue as shown in FIG. 4.4). We have demonstrated that DBC can be used to create large-area multi-color macroporous polymer films by consecutive coatings of particles of different sizes.

Besides flat displays, proof-of-concept experiment as shown in FIG. 4.5 indicates that reflective color displays could also be fabricated on curved surface. This will be of interest for many commercial applications.

In summary, we have invented an inexpensive yet scalable nanomanufacturing technology for producing large-area reflective color displays that target low-end display market. The cost of the reflective color displays is much cheaper than any existing color displays. Besides display application, the macroporous polymer membranes could also be used as ultra-thin heat pipes for efficient heat management that are of interest in many important technological areas, such as high-speed computing, space shuttles and pipelines.

### Example 4

### Brief Introduction

This Example describes a simple and roll-to-roll compatible coating technology for producing three-dimensionally highly ordered colloidal crystal-polymer nanocomposites, colloidal crystals, and macroporous polymer membranes. A vertically beveled doctor blade is utilized to shear-align silica microsphere-monomer suspensions to form large-area nanocomposites in a single step. The polymer matrix and the silica microspheres can be selectively removed to create colloidal crystals and self-standing macroporous polymer membranes. The thickness of the shear-aligned crystal is correlated with the viscosity of the colloidal suspension and the coating speed and the correlations can be qualitatively explained by adapting the mechanisms developed for conventional doctor blade coating. We further demonstrate that the doctor blade coating speed can be significantly increased by using a dual-blade setup. The optical properties of the self-assembled structures are evaluated by normal-incidence reflection measurements and the experimental results agree well with the theoretical predictions using Bragg's law and a scalar-wave approximation model. We have also demonstrated that the templated macroporous polymers with interconnected voids and uniform interconnecting nanopores can be directly used as filtration membranes to achieve size exclusive separation of particles.

### Introduction

The spontaneous crystallization of monodispersed colloidal particles is of considerable technological importance and great scientific interest in developing diffractive optical devices,¹⁻³ chemical and biological sensors,⁴⁻⁷ full-color displays,⁸⁻¹¹ ultrahigh-density optical and magnetic recording media,¹²⁻¹³ and model systems for fundamental studies of crystallization, melting and relaxation.¹⁴⁻¹⁸ The self-assembled colloidal arrays have also been extensively exploited as template to create a wide spectrum of functional periodic structures, such as macroporous photonic crystals with full photonic band gaps,¹⁹⁻²⁰ periodic metal nanostructures as surface-enhanced Raman scattering substrates,²¹⁻²⁶ biomimetic antireflection coatings for highly efficient solar cells,²⁷⁻²⁸ and separation media for macromolecules and DNA separation.²⁹⁻³⁰ Highly ordered colloidal crystal-polymer nanocomposites which have important technological applications ranging from photonic papers and displays to optical storage media and security data encryption can be prepared by filling the interstitials between the self-assembled colloidal arrays.³¹⁻³²

A large variety of methodologies, including gravitational sedimentation,³³ capillary force-induced self-assembly,^{19, 34-36} electrostatic repulsion,^{5, 37-38} physical confinement,³⁹⁻⁴⁰ electric and magnetic fields assisted assembly,^{11, 41-43} and shear force-induced ordering^{17, 44-51} have been developed to create high-quality colloidal crystals. Unfortunately, most of the available colloidal self-assembly technologies are only favorable for low volume, laboratory-scale production. It usually takes hours to days to create a centimeter-sized crystal. Technical incompatibility with mature microfabrication is another major issue for current colloidal self-assemblies. These issues greatly impede the economic and large-scale production of practical devices and therefore need to be addressed before bottom-up colloidal self-assembly reaches its full potential.

To resolve the scale-up and compatibility issues of current colloidal self-assembly, a spin-coating technology has recently been developed.^{14, 44-45,52} The methodology is based on shear-aligning concentrated colloidal suspensions by using standard spin-coating equipment. Spin-coating enables rapid production of wafer-sized colloidal arrays with remarkably large domain sizes and unusual non-close-packed structures.^{45, 52} However, this scalable technology is still a batch process. For industrial-scale mass-production, a roll-to-roll compatible continuous process is highly desired. Additionally, the shear force direction changes circularly in the spin-coating process. This leads to the formation of six-arm diffraction patterns on the sample surface,^{45, 52} impeding many optical applications (e.g., displays and optical filters) that require a uniform diffractive color.

Doctor blade coating (DBC) is widely used in the textile, paper, photographic film, printing, and ceramic industrial for creating highly uniform and flat films over large areas.⁵³⁻⁵⁷ In DBC, an immobilized blade applies a unidirectional shear force to a slurry that passes through a small gap between the blade and the substrate. This process is roll-to-roll compatible and has played a crucial role in ceramic processing to produce thin and flat ceramic tapes for dielectrics, fuel cells, batteries, and functionally graded materials.⁵³ Velev et al. developed a simplified DBC process,⁵⁸ which was originated from an evaporative colloidal assembly technology,⁵⁹⁻⁶¹ to create colloidal crystals with thickness ranging from a monolayer to a few layers. Capillary force is the major driving force for the colloidal crystallization in this process. Inspired by this technology, here we report a roll-to-roll compatible DBC technology for producing highly ordered colloidal crystal-polymer nanocomposites, colloidal crystals, and macroporous polymer membranes. The resulting three-dimensional (3D) ordered structures exhibit uniform diffractive colors. Most importantly, we demonstrate that the templated macroporous membranes with interconnected voids and uniform interconnecting nanopores can be directly used as filtration membranes to achieve size exclusive separation of particles.

### Experimental Section

### Materials And Substrates

All solvents and chemicals were of reagent quality and were used without further purification. Ethanol (200 proof) was purchased from Pharmaco Products. Ethoxylated trimethylolpropane triacrylate monomer (ETPTA, SR 454) was obtained from Sartomer. The photoinitiator, Darocur 1173 (2-hydroxy-2-methyl-1-phenyl-1-propanone), was provided by Ciba-Geigy. Silicon wafers (test grade, n type, Wafernet) and glass microslides (Fisher) were cleaned in a “Piranha” solution (a 3:1 mixture of concentrated sulfuric acid with 30% hydrogen peroxide) for half an hour, rinsed with Milli-Q water (18.2 MΩ cm), and dried in a stream of nitrogen.

### Instrumentation

Scanning electron microscopy (SEM) was carried out on a JEOL 6335F FEG-SEM. A thin layer of gold was sputtered onto the samples prior to imaging. Transmission electron microscopy (TEM) was performed on a JEOL 200CX TEM. The photopolymerization of ETPTA monomer was carried out on a pulsed UV curing system (RC 742, Xenon). A KD Scientific 780-230 syringe pump was used to precisely control the coating speed. The viscosity of colloidal suspensions was measured using an ARESLS-1 rheometer (TA Instruments). Oxygen plasma etching was performed on a Unaxis Shuttlelock RIE/ICP reactive-ion etcher.

Normal incidence optical reflection spectra were obtained using an Ocean Optics HR4000 High Resolution Fiber Optic Vis-near-IR spectrometer with a reflection probe. Optical transmission measurements of gold nanoparticle solutions were carried out on a ThermoSpectronic Genesys 10 UV-Vis spectrometer.

### Preparation of Colloidal Suspensions

The synthesis of monodispersed silica microspheres with less than 5% diameter variation was performed by following the well-established Stober method.⁶² The purified silica microspheres (by multiple centrifugation/re-dispersion cycles in 200-proof ethanol) were redispersed in ETPTA monomer using a Thermolyne vortex mixer. 2% (weight) Darocur 1173 was added as the photoinitiator. The final particle volume fraction of colloidal suspensions was adjusted from 20% to 50%. After filtration through a 5 μm syringe filter (Whatman) to remove any large particles, the transparent and viscous solution was stored in an open vial in dark for overnight to allow any residual ethanol to evaporate.

### Doctor Blade Coating

An immobilized and 90°-beveled razor blade (Fisher, 4 cm wide) was gently placed on a substrate. 1 mL of the above silica-ETPTA suspension was dispensed along one sidewall of the blade onto the substrate. The substrate was dragged by a syringe pump at a controlled speed. The blade could then spread the colloidal suspension uniformly on the substrate. After DBC, the sample was transferred to a pulsed UV curing system and ETPTA monomer was rapidly polymerized by exposure to UV radiation for 4 s. The polymer matrix could be removed by using a reactive ion etcher operating at 40 mTorr oxygen pressure, 40 SCCM flow rate, and 100 W for 10 min. To prepare macroporous polymers, the silica-ETPTA nanocomposites were immersed in a 2 vol. % hydrofluoric acid aqueous solution for 30 min, then rinsed with DI-water, and finally dried in a stream of nitrogen.

### Relative Viscosity Measurements

Experiments were performed using a 50-mm-diameter parallel-plate geometry to characterize the rheological properties of the colloidal suspensions under shear. The gap between plates was set to 500 μm in all experiments. To ensure that each test began from a similar initial state, the suspensions were pre-sheared at a rate of 100 s⁻¹ for 300 s, which was sufficient to enable the suspension to reach a steady state. The temperature was maintained at 25° C. and the temperature fluctuation was less than 0.05° C. during a typical test.

### Normal Incidence Optical Reflection Measurements

An Ocean Optics spectrometer with a reflection probe was used for reflectance measurements. A calibrated halogen light source was used to illuminate the sample. The beam spot size was about 3 millimeters on the sample surface. Measurements were performed at normal incidence and the cone angle of collection was less than 5°. Absolute reflectivity was obtained as ratio of the sample spectrum and the reference spectrum. The reference spectrum was the optical density obtained from an aluminum-sputtered (1000 nm thickness) silicon wafer. Final value of absolute reflectivity was the average of several measurements obtained from different spots on the sample surface.

### Results And Discussion

The schematic illustration of the DBC process for fabricating 3D highly ordered colloidal crystal-polymer nanocomposites is shown in FIG. 3.1. Monodispersed silica microspheres synthesized by the Stöber method are first dispersed in a nonvolatile monomer, ethoxylated trimethylolpropane triacrylate (ETPTA, M.W. 428, viscosity 60 cps), with 2 wt. % Darocur 1173 as photoinitiator. The particle volume fraction is adjusted from 20% to 50%. The resulting colloidal suspensions are transparent due to the refractive index (RI) matching between silica microspheres (RI˜1.42) and ETPTA monomer (RI˜1.46). The electrostatic repulsion between silica microspheres (zeta potential of ca. −45 mV in ETPTA)⁶³ stabilizes the suspensions for at least a few weeks. The suspensions are then dispensed along a sidewall of an immobilized and vertically beveled razor blade which gently touches with a substrate. A large variety of substrates including glass microslides, silicon wafers, and plastic plates can be used. The substrate is then dragged by a syringe pump in a controlled speed ranging from ˜0.1 μm/s to >1 mm/s. The razor blade offers a uniform shear force to align the suspended silica colloidal microspheres. The ETPTA monomer is finally photopolymerized by exposure to ultraviolet radiation to form 3D highly ordered colloidal crystal-polymer nanocomposites.

FIG. 3.2A shows a photograph of a multilayer silica colloidal crystal-ETPTA nanocomposite having 290 nm silica microspheres on a glass substrate illuminated with white light. The sample was prepared by DB-coating a 50 vol. % suspension at 0.1 μm/s. It exhibits a uniform red color caused by Bragg diffraction of visible light from the crystalline lattice. The long-range ordering of silica microspheres is clearly evident from the typical top-view SEM image as shown in FIG. 3.2B. The hexagonally arranged sharp peaks in the Fourier transform of a low-magnification SEM image (inset of FIG. 3.2B) further confirm the long-range hexagonal order. Common defects, such as point vacancies and misaligned lines which are caused mostly by dust particles and silica microspheres with extreme sizes, are also apparent in the SEM image. The polymer matrix surrounding the silica microspheres is clearly seen from the magnified top-view SEM image in FIG. 3.2C. The inter-particle distance of the colloidal crystal is calculated by the pair correlation function (PCF, FIG. 3.2D), g(r), which is obtained from a low-magnification image as in FIG. 3.2B as:

$$g ( r ) = \frac{1}{〈 ρ 〉} \frac{d n ( r , r + d r )}{d a ( r , r + d r )}$$

where [symbol] ρ [symbol] is the average particle number density and r is the particle radius. FIG. 3.2D shows the positions of the oscillating PCF peaks agree well with those obtained from a perfect hexagonal close-packed lattice.

The DBC technology can be utilized to align uniform silica microspheres with diameter ranging from ˜200 to ˜700 nm which can be easily synthesized by the Stober method.^{62, 64} FIG. 3.2E shows a top-view SEM image of a nanocomposite having 330 nm silica microspheres. The protrusion depth of 330 nm microspheres from the polymer matrix is apparently shallower than that of 290 nm spheres. This leads to the non-close-packed appearance of the microspheres as shown in FIG. 3.2E. Indeed, extensive PCF calculations reveal that the DB-coated colloidal crystals are close-packed. To evaluate the minimal particle size that still allows the formation of highly ordered nanocomposites using DBC, we tested 70 nm silica spheres synthesized by the microemulsion technology.⁶⁵⁻⁶⁶ However, only disordered arrays were resulted. As demonstrated in our previous spin-coating technology, a nearly I order of magnitude higher shear rate is required to align 70 nm silica spheres compared to 300 nm particles.⁶³ Besides ETPTA, a large variety of nonvolatile monomers and monomer mixtures can also be used to form highly ordered colloidal crystal-polymer nanocomposites by DBC, provided the concentrated silica-monomer suspensions are stable. FIG. 3.2F shows a top-view SEM image of a nanocomposite having 290 nm silica spheres and a hydrophilic polyethylene glycol (600) diacrylate (PEGDA, SR 610, Sartomer) matrix. The long-range ordering of the silica microspheres is similar to that of colloidal crystals prepared in other polymer matrix.

Crystalline thickness is another important parameter in determining the quality and application of self-assembled crystals. We therefore conducted systematic investigations on the effect of coating speed, particle size, and particle volume fraction on the resulting nanocomposite thickness. The results are summarized in FIG. 3.3 for silica microspheres of 290, 330, and 560 nm diameter. To obtain the average thickness and standard deviation, at least 3 samples were prepared under each condition and the crystal thicknesses at more than 10 random locations on each sample were measured by cross-sectional SEM. The crystalline quality of the sample was also monitored by SEM and the data points in FIG. 3.3 only indicated conditions by which highly ordered nanocomposites were obtained. By analyzing the results in FIG. 3.3, we found that (1) the nanocomposite becomes thicker when the coating speed increases; (2) the more dilute colloidal suspensions lead to thicker nanocomposites when the particle size and the coating speed remain the same; (3) larger particles lead to thicker samples when the particle volume fraction and the coating speed are the same; and (4) the operating window for obtaining highly ordered nanocomposites is narrower for the more dilute colloidal suspensions.

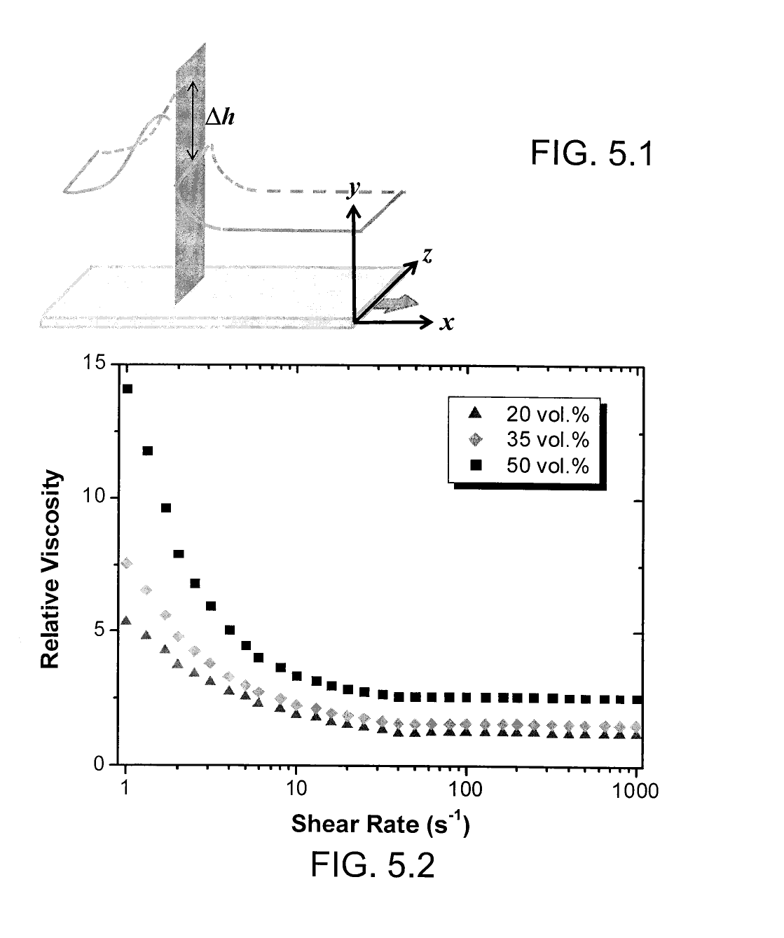

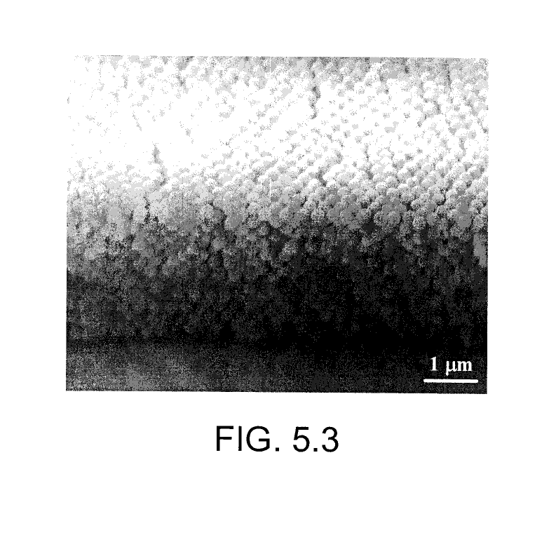

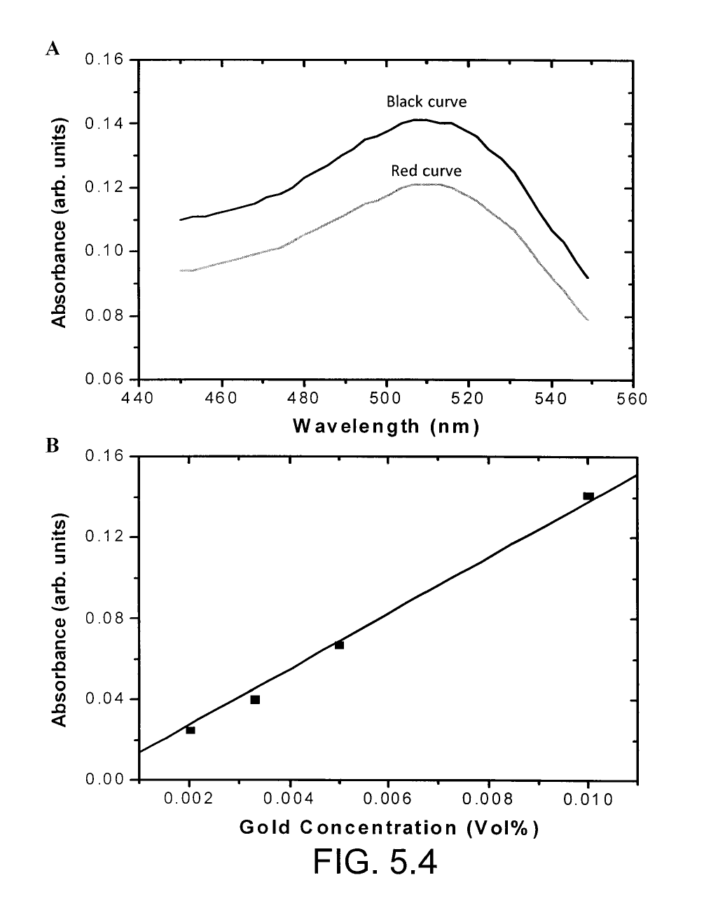

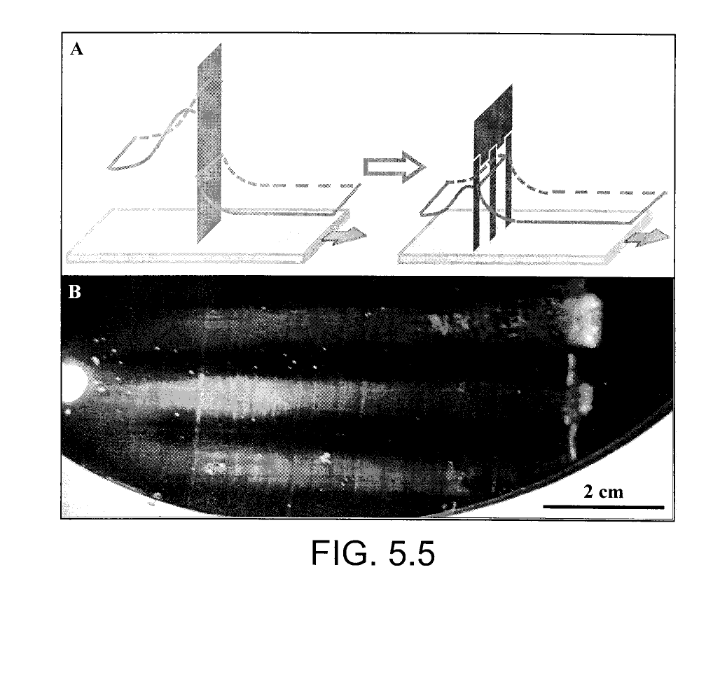

The above observations can be qualitatively explained by adapting the mechanisms developed for traditional DBC.⁵⁴⁻⁵⁷ In traditional DBC, both pressure-driven flow and shear-driven flow play a crucial role in determining the properties of the resulting coatings. The pressure-driven flow is caused by the pressure exerted by the colloidal suspension head, ΔAP=ρₛᵤₛₚₑₙₛᵢₒₙₛgΔh, where Δh is the height difference between the suspension reservoir and the DB-coated film (FIG. 5.1).⁵⁷ A higher pressure head leads to a larger flow rate across the blade. The shear-driven flow is attributed to the movement of the substrate and the corresponding shear stress (r) can be evaluated by using the Newton's law of viscosity (for Newtonian fluids) as:

$$τ = - μ \frac{d {υ}_{x}}{d y}$$

where μ is the viscosity of colloidal suspension, υₓ is the substrate velocity along the x direction.⁶⁷ As demonstrated in our previous work, the concentrated silica-ETPTA suspension is Newtonian over four decades of shear rate.⁶³ In a Newtonian fluid, the flow rates originated from the pressure head and the shear drag force are additive.⁵⁴

We attribute the observed colloidal crystallization in the above DBC procedures to shear-induced ordering.¹⁷ Highly ordered colloidal arrays form when the shear rate is sufficiently high. To evaluate the critical shear rate needed to align colloidal particles, we measured the relative viscosity (normalized by the viscosity of monomer, ˜60 cps for ETPTA) of silica-monomer suspensions with different particle volume fractions at various shear rates (FIG. 5.2). The obvious shear-thinning behavior is caused by shear-induced crystallization of colloidal particles and the reduced resistance when layers of ordered spheres glide over one another.^{17, 49} From FIG. 5.2, it is apparent that a critical shear rate of ˜10 s⁻¹ is needed to achieve the relative viscosity plateau. In our DBC procedures, the shear rate caused by the substrate drag alone is only ˜0.1 s⁻¹ by using typical substrate velocity (˜1 μm/s) and film thickness (˜10 μm). Therefore we deduce that the pressure-driven flow plays a more important role in determining the properties of the resulting films.

In our DBC setup (FIG. 5.1), the pressure head drives the flow of the colloidal suspensions across the small gap (<1 μm) between the blade and the substrate. The resulting film thickness is determined by this pressure and the suspension viscosity. A higher pressure and a lower viscosity lead to thicker films. From extensive experiments, we found that the suspension reservoir height was controlled by the coating speed˜a faster substrate velocity led to the more rapid accumulation of colloidal suspensions. This results in a higher pressure head and thus a thicker film, agreeing with the above observation 1. For a given particle size and coating speed, our experimental results in FIG. 5.2 show that the viscosities of the relatively dilute suspensions (35 vol. % and 20 vol. %) are less than that of the 50 vol. % suspension. Therefore, it is not surprised to observe the formation of thicker films for the more dilute colloidal suspensions (observation 2). The above observation 3 is also related to the viscosity of colloidal suspensions. Our previous results show that suspensions having large silica particles exhibit lower viscosity than that of suspensions of smaller particles with the same particle volume fraction.⁶³ To explain the observation 4, both suspension viscosity and shear rate effects need to be considered. From the Newton's law of viscosity, the shear stress is proportional to the suspension viscosity and the shear rate. For a more dilute suspension, the lower suspension viscosity and the thicker final films (i.e., a smaller shear rate) contribute synergistically to a smaller shear stress. Thus it is reasonable to observe the narrower operating window to obtain highly ordered nanocomposites for the more dilute suspensions. A detailed rheological study and an analytical fluid flow model are being developed and the results will be reported in our future publications.

The polymer matrix of the shear-aligned nanocomposites can be selectively removed by oxygen plasma etching to release the embedded silica colloidal crystals. FIG. 5.3 shows a cross-sectional SEM image of a colloidal crystal prepared by etching a nanocomposite sample at 40 mTorr oxygen pressure, 40 SCCM flow rate, and 100 W for 10 min. The long-range hexagonal ordering of the original nanocomposite is mostly retained in the final silica colloidal crystal, though some structural collapse during the polymer removal process is also noticed. This collapse makes the determination of the crystalline ordering and structure perpendicular to the substrate surface difficult. We therefore selectively etched out silica particles in the nanocomposites by a brief hydrofluoric acid (2 vol. %) wash to create macroporous polymers. The structure does not collapse during the etching process and the resulting film is easy to break to reveal the cross-section of the crystal. FIG. 3.4A shows a photograph of a free-standing macroporous ETPTA membrane templated from 290 nm silica spheres. The film exhibits a striking green color caused by the Bragg diffraction of visible light from the crystalline lattice of air cavities in the polymer. The typical SEM image of the top surface of a macroporous film and the Fourier transform of a lower-magnification image as shown in FIG. 3.4B reveals that the long-range hexagonal ordering of the shear-aligned nanocomposite is well retained during the wet etching process. A magnified SEM image in FIG. 3.4C further shows that the large voids templated from silica microspheres are interconnected through smaller pores which are originated from the touching sites of silica particles in the nanocomposites.^{20, 68} Extensive SEM characterizations confirm that the bottom side of the macroporous film has the same structure as the top surface. The crystalline ordering perpendicular to the (111) plane is clearly seen from the cross-sectional SEM image in FIG. 3.4D. However, a detailed SEM analysis shows that no relationship between neighboring layers (e.g., ABCABC . . . for a face-centered cubic crystal or ABABAB . . . for a hexagonal close-packed crystal) can be obtained. This suggests that the hexagonal close-packed layers are randomly stacked. Indeed, random stacking has been commonly observed in self-assembled colloidal crystals prepared by gravitational sedimentation and shear alignment.^{51, 69}

To further evaluate the optical properties and the crystalline structure of the DB-coated crystals, we measured the optical reflection at normal incidence using an Ocean Optics Vis-near-IR spectrometer with a reflection probe. FIG. 3.6A shows the reflection spectra obtained from a nanocomposite having 290 nm silica spheres and ETPTA matrix, and the corresponding silica colloidal crystal and macroporous ETPTA film. The samples were prepared by DBC at a speed of 0.1 μm/s and the film thickness was measured to be 12±1 monolayers by SEM. All three spectra show distinct peaks caused by the Bragg diffraction of visible and near-IR light from the 3D ordered structures. The low refractive index contrast of the nanocomposite and the partially collapsed structure of the silica colloidal crystal lead to the low reflection amplitudes of the corresponding spectra. The position of the diffraction peak can be correlated to the sphere size and the effective refractive index of the medium (n_{eff}) using Bragg's law: λₚₑₐₖ=2×n_{eff}×d×sin θ, where d is the interlayer spacing and sin θ=1 at normal incidence. The effective refractive index of the medium is calculated using: n_{eff}=n₁ f₁+n₂f₂, where n₁ and n₂ are refractive indices of the components and f₁ and f₂ are their corresponding volume fractions. FIG. 3.6A shows that the predicted peak positions as indicated by the arrows agree well with the experimental results. We have also conducted a more rigorous full-spectrum calculation using a scalar-wave approximation (SWA) model.⁷⁰ The calculated reflection spectrum from a macroporous ETPTA membrane with close-packed 290 nm voids and 12 monolayers is compared with the experimental spectrum in FIG. 3.6B. The remarkable agreement between theory and experiment further confirms the high crystalline quality of the shear-aligned crystals and the faithful replication of the original nanocomposite during the HF treatment.

Besides straightforward optical applications, the templated macroporous membranes with open and interconnected voids can be directly used as size exclusive filtration membranes for separating particles and other substances. Compared to common filtration membranes, such as track-etched polymer films and fiber-based membranes, the uniform size of the interconnecting nanopores and the high porosity of the templated macroporous polymers could enable more accurate fractionation of particulates and higher flow rate. To evaluate the separation efficiency of the templated macroporous films, we conducted a simple proof-of-concept experiment using a separation apparatus as shown in FIG. 3.5A. A 3-cm diameter macroporous ETPTA membrane templated from 290 nm silica spheres was used as the filter. The size of the interconnecting pores was estimated to be ˜50 nm by SEM. The testing solution was prepared by mixing ˜10 nm gold nanoparticles (0.01 vol. %) prepared by a chemical reduction method⁷¹⁻⁷² and 330 nm silica microspheres (0.01 vol. %) in ethanol. The resulting mixture is turbid (FIG. 3.5B) due to the random light scattering from 330 nm silica particles. The solution can easily pass through the macroporous polymer membrane even without applying a pressure or a vacuum. The filtrate solution is transparent and shows a red color (FIG. 3.5C) caused by the distinctive surface plasmon resonance absorption of light by Au nanoparticles (FIG. 5.4A). The complete removal of large silica microspheres is further confirmed by the TEM images in FIGS. 3.5D and 3.5E showing the samples prior to and after filtration, respectively.

We further evaluated the retention of small gold nanoparticles by the macroporous separation media. FIG. 5.4A compares the extinction spectra of the solutions in FIGS. 3.5B and 3.5C. Both samples show clear surface plasmon resonance peaks at ca. 510 nm. The peak amplitude of the filtrated solution is lower than that of the original mixture due to the loss of gold nanoparticles during the filtration process. We plotted the absorbance of gold nanoparticle solutions with different concentrations at 510 nm (FIG. 5.4B) as a calibration curve to determine the gold nanoparticle concentrations prior to and after filtration. The results demonstrated that more than 85% of gold nanoparticles were recovered after filtration. Besides hydrophobic ETPTA, a large variety of polymers ranging from highly hydrophilic PEGDA to highly hydrophobic fluorinated polymers (e.g., perfluoroether acrylates) can be used in DBC to create macroporous filtration membranes.

We have demonstrated above that the single-blade coating process can be utilized to create high-quality nanocomposites, colloidal crystals, and self-standing macroporous polymer membranes. Limited by the size of the commonly used doctor blades and the simple experimental setup, we have only fabricated centimeter-sized samples as proof-of-concept examples in this work. Similar DBC procedures using larger blades (up to meters long) and commercial DB coaters have been widely employed for creating highly uniform coatings over large areas in continuous roll-to-toll processing (similar to printing newpapers).⁵³⁻⁵⁷ As stable colloidal silica-monomer suspensions are easily available in large quantities, we believe that much larger colloidal arrays can be mass-produced by using the mature DBC technology. However, to reach the full potential of the roll-to-roll compatible DBC process in large-scale fabrication of highly ordered nanocomposites, the coating speed which is limited to ˜5 μm/s by a single-blade setup (FIG. 3.3) needs to be significantly improved. The rapid accumulation of excess colloidal suspensions which leads to a higher pressure and a thicker film reduces the achievable shear rate and the resulting crystalline quality in a fast coating system. To eliminate excess suspensions, we developed a dual-blade setup as shown by the scheme in FIG. 5.5A. The first blade removes excess colloidal suspensions and creates a uniform thin film. The second blade which is composed of 3 separate sub-blades then shear-align the colloidal microspheres underneath them. FIG. 5.5B shows a photograph of a sample coated at 1 mm/s by using the dual-blade setup. The sample does not show iridescent colors after passing the first blade, indicating no long-range ordering in the sample. After crossing the second blade, three iridescent stripes underneath the sub-blades are clearly evident; while no diffractive colors are observed in between. This indicates that the shear stress provided by the sub-blades is sufficiently high to align the particles at high coating speed. These striped colloidal arrays could find potential applications in diffractive optical devices and are available by other self-assembly technologies.⁷³ If we use a normal doctor blade instead of a blade with 3 sub-blades as the second blade in the dual-blade setup (FIG. 5.5A), the stripe patterns as shown in FIG. 5.5B can be prevented.

### Conclusions

In conclusion, we have developed a scalable doctor blade coating technology for fabricating 3D highly ordered nanocomposites, colloidal crystals, and macroporous polymers. Embodiments of the present disclosure can be used to produce large-area coatings that have important technological applications in diffractive optics, full-color displays, and size exclusive filtration membranes.

### REFERENCES, WHICH IS INCORPORATED HEREIN BY REFERENCE

(1) Weissman, J. M.; Sunkara, H. B.; Tse, A. S.; Asher, S. A. Science 1996, 274, 959.
(2) Kamenetzky, E. A.; Magliocco, L. G.; Panzer, H. P. Science 1994, 263, 207.
(3) Kim, S. H.; Jeong, W. C.; Yang, S. M. Chem. Mater. 2009, 21, 4993.
(4) Asher, S. A.; Alexeev, V. L.; Goponenko, A. V.; Sharma, A. C.; Lednev, I. K.; Wilcox, C. S.; Finegold, D. N. J. Am. Chem. Soc. 2003, 125, 3322.
(5) Holtz, J. H.; Asher, S. A. Nature 1997, 389, 829.
(6) Velev, O. D.; Kaler, E. W. Langmuir 1999, 15, 3693.
(7) Baksh, M. M.; Jaros, M.; Groves, J. T. Nature 2004, 427, 139.
(8) Arsenault, A. C.; Puzzo, D. P.; Ghoussoub, A.; Manners, I.; Ozin, G. A. J. Soc. Info. Display 2007, 15, 1095.
(9) Arsenault, A. C.; Puzzo, D. P.; Manners, I.; Ozin, G. A. Nat. Photonics 2007, 1, 468.
(10) Ge, J. P.; He, L.; Goebl, J.; Yin, Y. D. J. Am. Chem. Soc. 2009, 131, 3484.
(11) Ge, J. P.; Yin, Y. D. J. Mater. Chem. 2008, 18, 5041.
(12) Paquet, C.; Kumacheva, E. Mater. Today 2008, 11, 48.
(13) Sun, S. H.; Murray, C. B.; Weller, D.; Folks, L.; Moser, A. Science 2000, 287, 1989.
(14) Wu, Y. L.; Derks, D.; van Blaaderen, A.; Imhof, A. Proc. Natl. Acad. Sci. USA 2009, 106, 10564.
(15) Ackerson, B. J.; Clark, N. A. Phys. Rev. Lett. 1981, 46, 123.
(16) Zhu, J. X.; Li, M.; Rogers, R.; Meyer, W.; Ottewill, R. H.; Russell, W. B.; Chaikin, P. M. Nature 1997, 387, 883.
(17) Vermant, J.; Solomon, M. J. J. Phys: Condens. Matter 2005, 17, R187.
(18) Pieranski, P. Contemp. Phys. 1983, 24, 25.
(19) Vlasov, Y. A.; Bo, X. Z.; Sturm, J. C.; Norris, D. J. Nature 2001, 414, 289.
(20) Blanco, A.; Chomski, E.; Grabtchak, S.; Ibisate, M.; John, S.; Leonard, S. W.; Lopez, C.;

Meseguer, F.; Miguez, H.; Mondia, J. P.; Ozin, G. A.; Toader, O.; van Driel, H. M. Nature 2000, 405, 437.
(21) Dieringer, J. A.; McFarland, A. D.; Shah, N. C.; Stuart, D. A.; Whitney, A. V.; Yonzon, C. R.; Young, M. A.; Zhang, X. Y.; Van Duyne, R. P. Faraday Discuss. 2006, 132, 9.
(22) Hulteen, J. C.; Treichel, D. A.; Smith, M. T.; Duval, M. L.; Jensen, T. R.; Van Duyne, R. P. J. Phys. Chem. B 1999, 103, 3854.
(23) Zhang, X. Y.; Young, M. A.; Lyandres, O.; Van Duyne, R. P. J. Am. Chem. Soc. 2005, 127, 4484.
(24) Tessier, P. M.; Velev, O. D.; Kalambur, A. T.; Rabolt, J. F.; Lenhoff, A. M.; Kaler, E. W. J. Am. Chem. Soc. 2000, 122, 9554.
(25) Cintra, S.; Abdelsalam, M. E.; Bartlett, P. N.; Baumberg, J. J.; Kelf, T. A.; Sugawara, Y.; Russell, A. E. Faraday Discuss. 2006, 132, 191.
(26) Jang, S. G.; Choi, D. G.; Heo, C. J.; Lee, S. Y.; Yang, S. M. Adv. Mater. 2008, 20, 4862.
(27) Min, W. L.; Jiang, B.; Jiang, P. Adv. Mater. 2008, 20, 3914.
(28) Zhu, J.; Yu, Z. F.; Burkhard, G. F.; Hsu, C. M.; Connor, S. T.; Xu, Y. Q.; Wang, Q.; McGehee, M.; Fan, S. H.; Cui, Y. Nano Lett. 2009, 9, 279.
(29) Liu, L.; Li, P. S.; Asher, S. A. Nature 1999, 397, 141.
(30) Nykypanchuk, D.; Strey, H. H.; Hoagland, D. A. Science 2002, 297, 987.
(31) Fudouzi, H.; Xia, Y. N. Langmuir 2003, 19, 9653.
(32) Pham, H. H.; Gourevich, I.; Oh, J. K.; Jonkman, J. E. N.; Kumacheva, E. Adv. Mater. 2004, 16, 516.
(33) Mayoral, R.; Requena, J.; Moya, J. S.; Lopez, C.; Cintas, A.; Miguez, H.; Meseguer, F.; Vazquez, L.; Holgado, M.; Blanco, A. Adv. Mater. 1997, 9, 257.
(34) Denkov, N. D.; Velev, O. D.; Kralchevsky, P. A.; Ivanov, I. B.; Yoshimura, H.; Nagayama, K. Nature 1993, 361, 26.
(35) Jiang, P.; Bertone, J. F.; Hwang, K. S.; Colvin, V. L. Chem. Mater. 1999, 11, 2132.
(36) Wong, S.; Kitaev, V.; Ozin, G. A. J. Am. Chem. Soc. 2003, 125, 15589.
(37) Yethiraj, A.; van Blaaderen, A. Nature 2003, 421, 513.
(38) Jethmalani, J. M.; Sunkara, H. B.; Ford, W. T.; Willoughby, S. L.; Ackerson, B. J. Langmuir 1997, 13, 2633.
(39) van Blaaderen, A.; Ruel, R.; Wiltzius, P. Nature 1997, 385, 321.
(40) Park, S. H.; Xia, Y. N. Langmuir 1999, 15, 266.
(41) Hayward, R. C.; Saville, D. A.; Aksay, I. A. Nature 2000, 404, 56.
(42) Trau, M.; Saville, D. A.; Aksay, I. A. Science 1996, 272, 706.
(43) Lumsdon, S. O.; Kaler, E. W.; Williams, J. P.; Velev, O. D. Appl. Phys. Lett. 2003, 82, 949.
(44) Shereda, L. T.; Larson, R. G.; Solomon, M. J. Phys. Rev. Lett. 2008, 101, 038301.
(45) Jiang, P.; McFarland, M. J. J. Am. Chem. Soc. 2004, 126, 13778.
(46) Amos, R. M.; Rarity, J. G.; Tapster, P. R.; Shepherd, T. J.; Kitson, S. C. Phys. Rev. E 2000, 61, 2929.
(47) Dux, C.; Versmold, H. Phys. Rev. Lett. 1997, 78, 1811.
(48) Vickreva, O.; Kalinina, O.; Kumacheva, E. Adv. Mater. 2000, 12, 110.
(49) Ackerson, B. J. J. Phys.-Condes. Matter 1990, 2, SA389.
(50) Hoffman, R. L. Trans. Soc. Rheol. 1972, 16, 155.
(51) Ruhl, T.; Spahn, P.; Hellmann, G. P. Polymer 2003, 44, 7625.
(52) Jiang, P.; Prasad, T.; McFarland, M. J.; Colvin, V. L. Appl. Phys. Lett. 2006, 89, 011908.
(53) Mistler, R. E.; Twiname, E. R. Tape Casting: Theory and Practice; American Ceramic Society: Westerville, Ohio 2000.
(54) Chou, Y. T.; Ko, Y. T.; Yan, M. F. J. Am. Ceram. Soc. 1987, 70, C280.
(55) Loest, H.; Lipp, R.; Mitsoulis, E. J. Am. Ceram. Soc. 1994, 77, 254.
(56) Pitchumani, R.; Karbhari, V. M. J. Am. Ceram. Soc. 1995, 78, 2497.
(57) Kim, H. J.; Krane, M. J. M.; Trumble, K. P.; Bowman, K. J. J. Am. Ceram. Soc. 2006, 89, 2769.
(58) Prevo, B. G.; Velev, O. D. Langmuir 2004, 20, 2099.
(59) Adachi, E.; Nagayama, K. Langmuir 1996, 12, 1836.
(60) Dimitrov, A. S.; Nagayama, K. Langmuir 1996, 12, 1303.
(61) Matsushita, S.; Miwa, T.; Fujishima, A. Langmuir 1997, 13, 2582.
(62) Stober, W.; Fink, A.; Bohn, E. J. Colloid Interf. Sci. 1968, 26, 62.
(63) Min, W. L.; Jiang, P.; Jiang, B. Nanotechnology 2008, 19, 475604.
(64) Bogush, G. H.; Tracy, M. A.; Zukoski, C. F. J. Non-Cryst. Solids 1988, 104, 95.
(65) Johnson, S. A.; Ollivier, P. J.; Mallouk, T. E. Science 1999, 283, 963.
(66) Arriagada, F. J.; Osseo-Asare, K. J. Colloid Interface Sci. 1999, 211, 210.
(67) Bird, R. B.; Stewart, W. E.; Lightfoot, E. N. Transport Phenomena; 2nd ed.; Wiley: Chichester, N.Y., 1999.
(68) Jiang, P.; Hwang, K. S.; Mittleman, D. M.; Bertone, J. F.; Colvin, V. L. J. Am. Chem. Soc. 1999, 121, 11630.
(69) Hoogenboom, J. P.; Derks, D.; Vergeer, P.; van Blaaderen, A. J. Chem. Phys. 2002, 117, 11320.
(70) Mittleman, D. M.; Bertone, J. F.; Jiang, P.; Hwang, K. S.; Colvin, V. L. J. Chem. Phys. 1999, 111, 345.
(71) Brinson, B. E.; Lassiter, J. B.; Levin, C. S.; Bardhan, R.; Mirin, N.; Halas, N. J. Langmuir 2008, 24, 14166.
(72) Duff, D. G.; Baiker, A.; Edwards, P. P. Langmuir 1993, 9, 2301.
(73) Watanabe, S.; Inukai, K.; Mizuta, S.; Miyahara, M. T. Langmuir 2009, 25, 7287.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A structure comprising:
a porous polymer membrane including an ordered array of voids, wherein the distance between at least two pairs of adjacent voids is substantially the same, wherein a polymer framework separates the voids, wherein the voids extend the entire thickness of the porous polymer membrane to form a channel through the porous polymer membrane.

2. The structure of claim 1, wherein the distance between each pair of adjacent voids is substantially the same.

3. The structure of claim 1, wherein the distance between 50% of the pairs of adjacent voids is substantially the same.

4. The structure of claim 1, wherein the distance between 75% of the pairs of adjacent voids is substantially the same.

5. The structure of claim 1, wherein the distance between 90% of the pairs of adjacent voids is substantially the same.

6. The structure of claim 1, wherein the number of unique pairs is about 10 to 1×10²⁰.

7. The structure of claim 1, wherein each void has a diameter that is about the same.

8. The structure of claim 1, wherein the diameter of the void is about 0.03 micrometers to 10 micrometers.

9. The structure of claim 1, wherein the polymer of the polymer framework is selected from the group consisting of: a photocurable polymer, a thermocurable polymer, a mixture of photocurable polymers, a mixture of thermocurable polymers, and a combination thereof.

10. The structure of claim 1, wherein the distance between a pair of adjacent voids is about 0.03 micrometers to 10 micrometers.

11. The structure of claim 1, wherein the porous polymer membrane has a thickness of about 1 micrometer to 300 micrometers.

12. A device, comprising:
a first structure, wherein the first structure is the structure of claim 1, and
a fluid structure adapted for moving a fluid into and out of a portion of the voids of the first structure, wherein the portion of the first structure has a first color when the fluid is within the void and a second color when the void does not include the fluid, wherein the first structure and the fluid structure are in fluidic communication.

13. The device of claim 12, wherein the fluid has the same refractive index as the porous polymer membrane.

14. The device of claim 12, wherein the fluid structure uses heat to control the movement of the fluid into and out of a portion of the voids.

15. The device of claim 12, further comprising a second structure, wherein the second structure is the structure of claim 1, wherein the fluid structure is adapted for moving the fluid into and out of a portion of the voids of the second structure independent of moving fluid into and out of a portion of the voids of the first structure.

16. The device of claim 15, wherein the first structure is disposed on top of the second structure so that the first structure and the second structure overlap one another.

17. The device of claim 12, wherein the first color is transparent and the second color is a shining non-transparent color.

18. A filter, comprising: a structure of claim 1.

19. A display sign, comprising: a device of claim 12.

20. A method of making a structure, comprising:
disposing a monomer/nanoparticle mixture onto a surface to form an array of nanoparticles, wherein the distance between at least two pairs of adjacent nanoparticles is substantially the same;
polymerizing the monomer to form a polymer framework around a portion of the nanoparticles; and
removing the nanoparticles to form an ordered array of voids, wherein the distance between at least two pairs of adjacent voids is substantially the same, wherein the polymer framework separates the voids, wherein the voids extend the entire thickness of the porous polymer membrane.

21. The method of claim 20, wherein the nanoparticles are silica nanoparticles.

22. The method of claim 20, wherein polymerizing is selected from a photochemical polymerization, a thermochemical polymerization, and a combination thereof, of the monomer to form the polymer.

23. The method of claim 20, wherein removing includes dissolving the nanoparticles.

24. The method of claim 20, wherein the distance between each pair of adjacent voids is substantially the same.

25. The method of claim 20, wherein the distance between 50% of the pairs of adjacent voids is substantially the same.

26. The method of claim 20, wherein the distance between 75% of the pairs of adjacent voids is substantially the same.

27. The method of claim 20, wherein the distance between 90% of the pairs of adjacent voids is substantially the same.

28. The method of claim 20, wherein the number of unique pairs is about 10 to 1×10²⁰.
